(19) United States
(12) Patent Application Publication
(10) Pub. No.: US 2021/0297437 A1
(43) Pub. Date: Sep. 23, 2021

(54) Security Analytics System Configured to Instantiate User Behavior Baselines Using Historical Data Stored on an Endpoint Device

(71) Applicant: Forcepoint, LLC, Austin, TX (US)

(72) Inventors: Lawrence Bruce Huston, III, Ann Arbor, MI (US); David Coffey, Austin, TX (US)

(21) Appl. No.: 16/826,674

(22) Filed: Mar. 23, 2020

(51) Int. Cl. H04L 29/06

(52) U.S. Cl. CPC H04L 63/1425; H04L 63/1416

(57) ABSTRACT

A system, method, and computer-readable medium are disclosed for implementing a security analytics system configured to instantiate user behavior baselines using historical data stored on an endpoint device. At least one embodiment is directed to a computer-implemented method including: accessing historical data stored on an endpoint device during an initialization of the endpoint device on the secured network, instantiating user behavior baselines for the endpoint device using the accessed historical data, and storing the instantiated user behavior baselines on a security system of the secured network for detecting instances of anomalous user behavior occurring at the endpoint device. Other embodiments of this aspect include corresponding computer systems, apparatus, and computer programs recorded on one or more computer storage devices, each configured to perform the actions of the methods.

### BACKGROUND OF THE INVENTION

### Field of the Invention

The present invention relates in general to the field of computers and similar technologies, and in particular to cybersecurity systems utilized in this field. Still more particularly, it relates to a method, system, and computer-usable medium for instantiating user behavior baselines using historical data stored on an endpoint device.

### Description of the Related Art

Users interact with physical, system, data, and services resources of all kinds, as well as each other, on a daily basis. Each of these interactions, whether accidental or intended, poses some degree of security risk, depending on the behavior of the user. In particular, the actions of a formerly trusted user may become malicious as a result of being subverted, compromised or radicalized due to any number of internal or external factors or stressors. For example, financial pressure, political idealism, irrational thoughts, or other influences may adversely affect a user's intent and/or behavior.

### SUMMARY OF THE INVENTION

A system of one or more computers can be configured to perform particular operations or actions by virtue of having software, firmware, hardware, or a combination of them installed on the system that in operation causes or cause the system to implement a security analytics system configured to instantiate user behavior baselines using historical data stored on an endpoint device. One general aspect includes a computer-implemented method for instantiating user behavior baselines in a secured network. The computer-implemented method includes accessing historical data stored on an endpoint device during an initialization of the endpoint device on the secured network, instantiating user behavior baselines for the endpoint device using the accessed historical data, and storing the instantiated user behavior baselines on a security system of the secured network for detecting instances of anomalous user behavior occurring at the endpoint device. Other embodiments of this aspect include corresponding computer systems, apparatus, and computer programs recorded on one or more computer storage devices, each configured to perform the actions of the methods.

Another general aspect is implemented using one or more information handling systems, where the one or more information handling systems include: a processor; a data bus coupled to the processor; and a non-transitory, computer-readable storage medium embodying computer program code in the non-transitory, which is coupled to the data bus. The computer program code included in one or more of the information handling systems is executable by the processor of the information handling system so that the information handling system, alone or in combination with other information handling systems, executes operations including: accessing historical data stored on an endpoint device during an initialization of the endpoint device on a secured network; instantiating user behavior baselines for the endpoint device using the accessed historical data; and storing the instantiated user behavior baselines on a security system of the secured network for detecting instances of anomalous user behavior occurring at the endpoint device.

Another general aspect includes a non-transitory, computer-readable storage medium embodying computer program code, where the computer program code comprises computer-executable instructions configured for: accessing historical data stored on an endpoint device during an initialization of the endpoint device on a secured network; instantiating user behavior baselines for the endpoint device using the accessed historical data, and storing the instantiated user behavior baselines on a security system of the secured network for detecting instances of anomalous user behavior occurring at the endpoint device.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of an edge device;

FIG. 3 is a simplified block diagram of an endpoint agent;

FIG. 4 is a simplified block diagram of a security analytics system;

FIG. 5 is a simplified block diagram of a security analytics system;

FIG. 6 shows components of an endpoint device in which historical data is retrieved by an endpoint initialization engine to instantiate a set of user behavior baselines;

FIG. 7 shows a flowchart of exemplary operations that may be executed in certain embodiments of the disclosed system to instantiate user behavior baselines

FIGS. 8a and 8b show a simplified block diagram of an entity behavior profile (EBP) and an initial set of instantiated user behavior baselines that may be incorporated into the EBP;

FIGS. 9a and 9b show a block diagram of a security analytics system environment;

FIG. 10 is a flowchart showing exemplary operations that may be executed while using instantiated user behavior baselines in certain embodiments of the disclosed system;

FIG. 11 is a simplified block diagram showing the mapping of an event to a security vulnerability scenario;

FIG. 12 is a simplified block diagram of the generation of a session and a corresponding session-based fingerprint;

FIG. 13 is a simplified block diagram of process flows associated with the operation of an entity behavior catalog (EBC) system;

FIG. 14 illustrates certain operations that may be executed in response to the receipt of information associated with a series of events.

### DETAILED DESCRIPTION

A method, system, and computer-usable medium are disclosed for cataloging entity behavior. Certain aspects of the disclosed system include an appreciation that the existence of any entity, whether it is an individual user, a group of users, an organization, a device, a system, a network, an account, a domain, an operation, a process, a software application, or a service, represents some degree of security risk. Accordingly, certain aspects of the disclosure include an appreciation that a particular entity can be assigned a measure of risk according to its respective attributes, behaviors, associated behavioral models, and resultant inferences contained in an associated profile.

As an example, a user profile may have a certain set of behaviors indicative of how the user normally interacts with an information handling system. To implement behavioral detection, baselines of standard behaviors are employed to detect when a current behavior is abnormal. The analytics system takes the user's current behavior and compares it to baseline behaviors. Deviations from the baseline behaviors can generate an indicator that signals that the corresponding entity is not acting in conformance with such baseline behaviors but, rather, is exhibiting the behaviors that deviate from the baseline.

As an example, baseline behaviors may be used in novelty detection in which the security analytics system compares a current action (visiting a website, running a program, etc.) to the user's prior actions. If the user has never visited the website, then the visit may be treated as novel and create an indicator that the action is unique. While the indicator need not generate an alert by itself, the indicator can be combined with additional indicators to detect anomalous and/or potentially malicious behavior. Likewise, certain embodiments of the disclosed system include an appreciation that various user behavior factors may be used to determine whether a behavior is anomalous, abnormal, unexpected, malicious, or some combination thereof.

Certain aspects of the disclosed system appreciate that baselines for a user often start from scratch. Generation of a useful behavior baseline is often established by monitoring the user's behavior over time, which can be from days to weeks and the making. Waiting to build baselines can be problematic when onboarding new users since the user may exhibit abnormal behavior during the time in which the baseline is built.

Certain aspects of the disclosed system appreciate that a behavior baseline may be instantiated using historical data stored on an endpoint device that has been operated by the user. In certain embodiments, the historical data is accessed by the security analytics system and used to instantiate a set of baseline behaviors that may be used by a security analytics system to detect anomalous user behavior while a more useful user behavior baseline is generated over time. In certain embodiments, the initial set of baseline behaviors may be discarded once a more useful set of baseline behaviors is generated. In certain embodiments, the initial set of baseline behaviors are enhanced over time to provide a more useful set of baseline behaviors.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a mobile device such as a tablet or smartphone, a consumer electronic device, a connected “smart device,” a network appliance, a network storage device, a network gateway device, a server or collection of servers or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more wired or wireless interfaces for communicating with other networked devices, external devices, and various input and output (I/0) devices, such as a keyboard, a mouse, a microphone, speakers, a trackpad, a touchscreen and a display device (including a touch-sensitive display device). The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or solid-state drive), a sequential access storage device (e.g., a tape disk drive), optical storage device, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

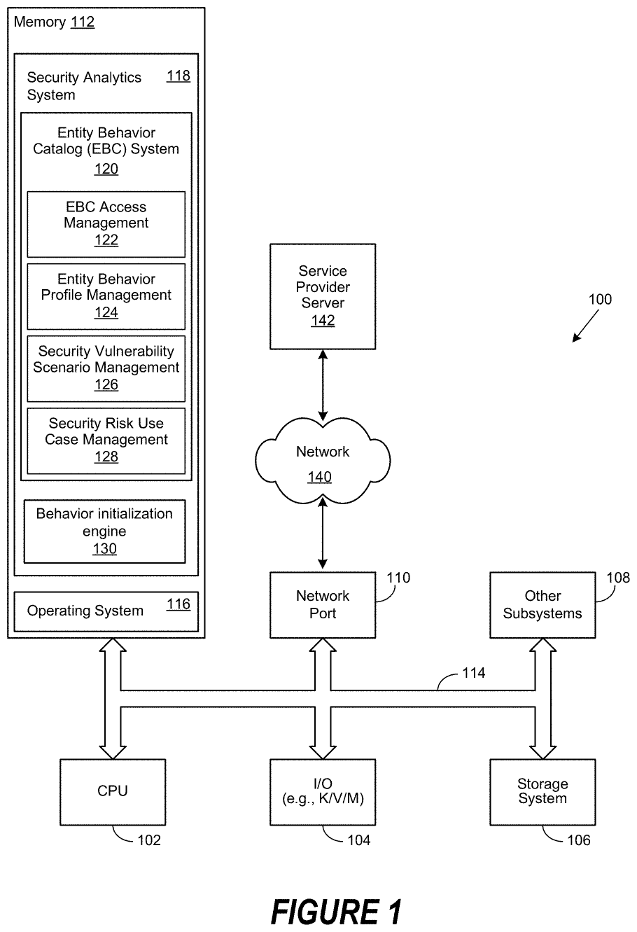

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a storage system 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further includes an operating system (OS) 116 and, in various embodiments, may also include a security analytics system 118. In one embodiment, the information handling system 100 is able to download the security analytics system 118 from the service provider server 142. In another embodiment, the security analytics system 118 is provided as a service from the service provider server 142.

In various embodiments, the security analytics system 118 performs a security analytics operation. In certain embodiments, the security analytics operation improves processor efficiency, and thus the efficiency of the information handling system 100, by facilitating security analytics functions. As will be appreciated, once the information handling system 100 is configured to perform the security analytics operation, the information handling system 100 becomes a specialized computing device specifically configured to perform the security analytics operation and is not a general-purpose computing device. Moreover, the implementation of the security analytics system 118 on the information handling system 100 improves the functionality of the information handling system 100 and provides a useful and concrete result of performing security analytics functions to mitigate security risk. In certain embodiments, the security analytics system 118 may be implemented to include an entity behavior catalog (EBC) system 120. In certain embodiments, the EBC system 120 may be implemented to catalog entity behavior. In certain embodiments, the EBC system 120 may likewise be implemented to include an EBC access management module 122, an EBP management module 124, a security vulnerability scenario management module 126, and a security risk use case management 128 module, or a combination thereof.

In certain embodiments, the security analytics system 118 may include a behavior initialization engine 130 configured to instantiate a set of baseline behaviors that may be used to detect anomalous user behaviors while a more useful set of user behavior baselines is developed over time as the security analytics system monitors the interactions between the user and the secured information handling system over time. As described herein, the behavior initialization engine 130 may be configured to use historical data retrieved from a user's endpoint device that when the user's endpoint device is added to a secured system. In certain embodiments, the user behavior baselines are instantiated when the endpoint device is installed on the secured information handling system.

In certain embodiments, a user behavior baseline is instantiated for an existing endpoint device when an analytics feature is configured to use a new user behavior. As an example, a new analytics feature may be added to the security analytics system that requires the security analytics system to develop a user behavior baseline for the behavior that is to be analyzed. In such instances, certain embodiments use the historical data associated with the new user behavior to instantiate a user behavior baseline for initial use in the new analytics feature while a potentially more useful behavior baseline for the new feature is developed over time.

In various embodiments, the EBC access management module 122 may be implemented to perform certain EBC access management operations. In various embodiments, the EBP management module 124 may be implemented to perform certain EBP management operations. Likewise, the security vulnerability scenario management module 126 may be implemented in various embodiments to perform certain security vulnerability scenario management operations. In certain embodiments, the security risk use case management module 128 may be implemented to perform certain security risk use case management operations.

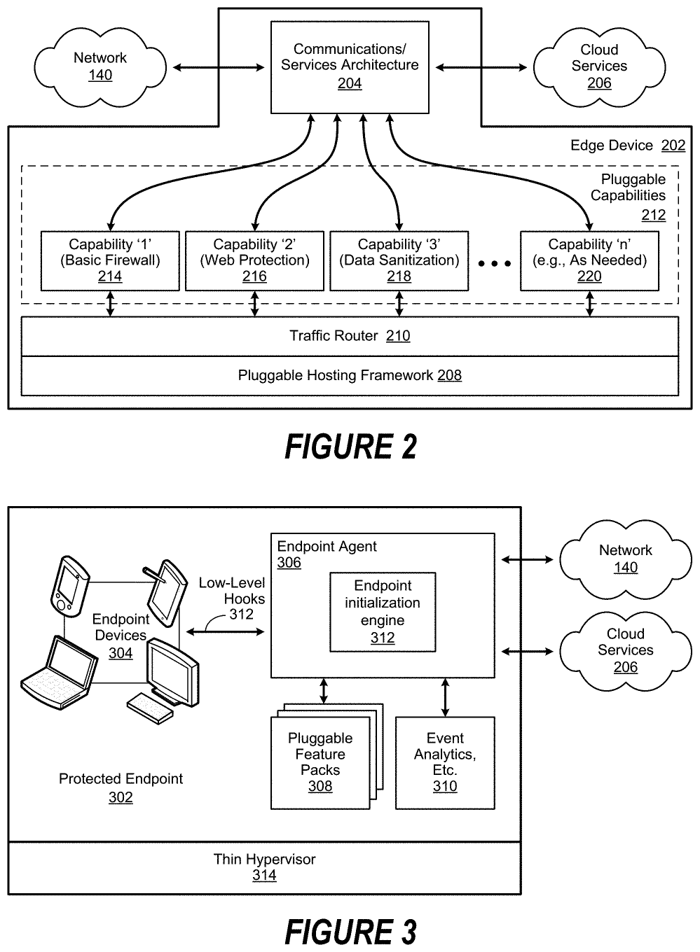

FIG. 2 is a simplified block diagram of an edge device implemented in accordance with an embodiment of the disclosed system. As used herein, an edge device, such as the edge device 202 shown in FIG. 2, broadly refers to a device providing an entry point into a network 140. Examples of such edge devices 202 may include routers, routing switches, integrated access devices (IADs), multiplexers, wide-area network (WAN) access devices, and network security appliances. In certain embodiments, the network 140 may be a private network (e.g., an enterprise network), a semi-public network (e.g., a service provider core network), or a public network (e.g., the Internet).

Skilled practitioners of the art will be aware that edge devices 202 are often implemented as routers that provide authenticated access to faster, more efficient backbone and core networks. Furthermore, current industry trends include making edge devices 202 more intelligent, which allows core devices to operate at higher speed as they are not burdened with additional administrative overhead. Accordingly, such edge devices 202 often include Quality of Service (QoS) and multi-service functions to manage different types of traffic. Consequently, it is common to design core networks with switches that use routing protocols such as Open Shortest Path First (OSPF) or Multiprotocol Label Switching (MPLS) for reliability and scalability. Such approaches allow edge devices 202 to have redundant links to the core network, which not only provides improved reliability, but enables enhanced, flexible, and scalable security capabilities as well.

In certain embodiments, the edge device 202 may be implemented to include a communications/services architecture 204, various pluggable capabilities 212, a traffic router 210, and a pluggable hosting framework 208. In certain embodiments, the communications/services architecture 204 may be implemented to provide access to and from various networks 140, cloud services 206, or a combination thereof In certain embodiments, the cloud services 206 may be provided by a cloud infrastructure familiar to those of skill in the art. In certain embodiments, the edge device 202 may be implemented to provide support for a variety of generic services, such as directory integration, logging interfaces, update services, and bidirectional risk/context flows associated with various analytics. In certain embodiments, the edge device 202 may be implemented to provide temporal information associated with the provision of such services.

In certain embodiments, the edge device 202 may be implemented as a generic device configured to host various network communications, data processing, and security management capabilities. In certain embodiments, the pluggable hosting framework 208 may be implemented to host such capabilities in the form of pluggable capabilities 212. In certain embodiments, the pluggable capabilities 212 may include capability ‘1’ 214 (e.g., basic firewall), capability ‘2’ 216 (e.g., general web protection), capability ‘3’ 218 (e.g., data sanitization), and so forth through capability ‘n’ 220, which may include capabilities needed for a particular operation, process, or requirement on an as-needed basis. In certain embodiments, such capabilities may include the performance of operations associated with managing an adaptive trust Profile (ATP). In certain embodiments, such operations may include the provision of associated temporal information (e.g., timestamps).

In certain embodiments, the pluggable capabilities 212 may be sourced from various cloud services 206. In certain embodiments, the pluggable hosting framework 208 may be implemented to provide certain computing and communication infrastructure components, and foundation capabilities, required by one or more of the pluggable capabilities 212. In certain embodiments, the pluggable hosting framework 208 may be implemented to allow the pluggable capabilities 212 to be dynamically invoked. Skilled practitioners of the art will recognize that many such embodiments are possible. Accordingly, the foregoing is not intended to limit the spirit, scope or intent of the disclosed system.

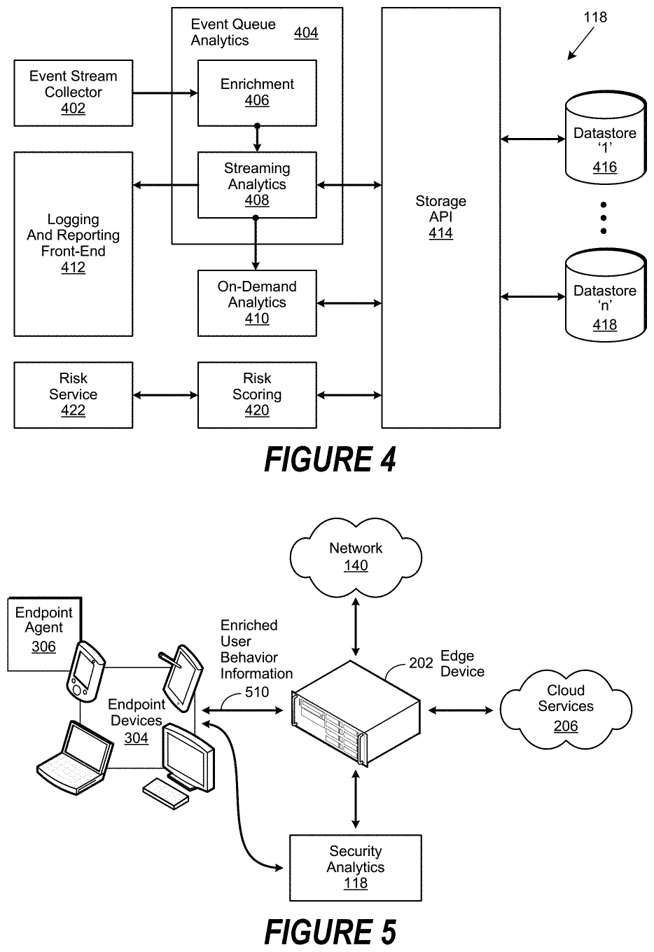

FIG. 3 is a simplified block diagram of an endpoint agent implemented in one example of the disclosed system. As used herein, an endpoint agent 306 broadly refers to a software agent used in combination with an endpoint device 304 to establish a protected endpoint 302. Skilled practitioners of the art will be familiar with software agents, which are computer programs that perform actions on behalf of a user or another program. In various approaches, a software agent may be autonomous or work together with another agent or a user. In certain of these approaches, the software agent is implemented to autonomously decide if a particular action is appropriate for a given event, such as an observed entity behavior.

An endpoint device 304, as likewise used herein, refers to an information processing system such as a personal computer, a laptop computer, a tablet computer, a personal digital assistant (PDA), a smartphone, a mobile telephone, a digital camera, a video camera, or other device capable of storing, processing and communicating data. In certain embodiments, the communication of the data may take place in real-time or near-real-time. As used herein, real-time broadly refers to the processing and providing information within a time interval brief enough to not be discernable by a user. As an example, a cellular phone conversation may be used to communicate information in real-time, while an instant message (IM) exchange may be used to communicate information in near real-time. In certain embodiments, the communication of the information may take place asynchronously. For example, an email message may be stored on an endpoint device 304 when it is offline. In this example, the information may be communicated to its intended recipient once the endpoint device 304 gains access to a network 140.

A protected endpoint 302, as likewise used herein, broadly refers to a policy-based approach to network security that typically requires endpoint devices 304 to comply with certain criteria before they are granted access to network resources. As an example, a given endpoint device 304 may be required to have a particular operating system (OS), or version thereof, a Virtual Private Network (VPN) client, anti-virus software with current updates, and so forth. In certain embodiments, the protected endpoint 302 may be implemented to perform operations associated with providing real-time resolution of the identity of an entity at a particular point in time. In certain embodiments, the protected endpoint 302 may be implemented to provide temporal information, such as timestamp information, associated with such operations.

In certain embodiments, the real-time resolution of the identity of an entity at a particular point in time may be based upon contextual information associated with a given entity behavior. As used herein, contextual information broadly refers to any information, directly or indirectly, individually or in combination, related to a particular entity behavior. In certain embodiments, entity behavior may include an entity's physical behavior, cyber behavior, or a combination thereof. As likewise used herein, physical behavior broadly refers to any entity behavior occurring within a physical realm. More particularly, physical behavior may include any action enacted by an entity that can be objectively observed, or indirectly inferred, within a physical realm.

As an example, a user may attempt to use an electronic access card to enter a secured building at a certain time. In this example, the use of the access card to enter the building is the action, and the reading of the access card makes the user's physical behavior electronically-observable. As another example, a first user may physically transfer a document to a second user, which is captured by a video surveillance system. In this example, the physical transferal of the document from the first user to the second user is the action. Likewise, the video record of the transferal makes the first and second user's physical behavior electronically-observable. As used herein, electronically-observable entity behavior broadly refers to any behavior exhibited or enacted by an entity that can be electronically observed.

Cyber behavior, as used herein, broadly refers to any behavior occurring in cyberspace, whether enacted by an individual user, a group of users, or a system acting at the behest of an individual user, a group of users, or an entity. More particularly, cyber behavior may include physical, social, or mental actions that can be objectively observed, or indirectly inferred, within cyberspace. As an example, a user may use an endpoint device 304 to access and browse a particular website on the Internet. In this example, the individual actions performed by the user to access and browse the website constitute a cyber behavior. As another example, a user may use an endpoint device 304 to download a data file from a particular system at a particular point in time. In this example, the individual actions performed by the user to download the data file, and associated temporal information, such as a time-stamp associated with the download, constitute a cyber behavior. In these examples, the actions are enacted within cyberspace, in combination with associated temporal information, which makes them electronically-observable.

As likewise used herein, cyberspace broadly refers to a network 140 environment capable of supporting communication between two or more entities. In certain embodiments, the entity may be a user, an endpoint device 304, or various resources. In certain embodiments, the entities may include various endpoint devices 304 or resources operating at the behest of an entity, such as a user. In certain embodiments, the communication between the entities may include audio, image, video, text, or binary data.

In certain embodiments, the contextual information may include a user's authentication factors. Contextual information may likewise include various temporal identity resolution factors, such as identification factors associated with the entity, the date/time/frequency of various entity behaviors, the entity's location, the entity's role or position in an organization, their associated access rights, and certain user gestures employed by a user in the enactment of a user behavior. Other contextual information may likewise include various user interactions, whether the interactions are with an endpoint device 304, a network 140, a resource, or another user. In certain embodiments, entity behaviors, and their related contextual information, may be collected at particular points of observation, and at particular points in time. In certain embodiments, a protected endpoint 302 may be implemented as a point of observation for the collection of entity behavior and contextual information.

In certain embodiments, the endpoint agent 306 may be implemented to universally support a variety of operating systems, such as Apple Macintosh®, Microsoft Windows®, Linux®, Android ® and so forth. In certain embodiments, the endpoint agent 306 may be implemented to interact with the endpoint device 304 through the use of low-level hooks 312 at the operating system level. It will be appreciated that the use of low-level hooks 312 allows the endpoint agent 306 to subscribe to multiple events through a single hook. Consequently, multiple functionalities provided by the endpoint agent 306 can share a single data stream, using only those portions of the data stream they may individually need. Accordingly, system efficiency can be improved, and operational overhead reduced.

In certain embodiments, the endpoint agent 306 may be implemented to provide a common infrastructure for pluggable feature packs 308. In various embodiments, the pluggable feature packs 308 may provide certain security management functionalities. Examples of such functionalities may include various anti-virus and malware detection, data loss protection (DLP), insider threat detection, and so forth. In certain embodiments, the security management functionalities may include one or more functionalities associated with providing real-time resolution of the identity of an entity at a particular point in time, as described in greater detail herein.

In certain embodiments, the endpoint agent 306 may include an endpoint initialization engine 312 that is invoked when the protected endpoint 302 is initially added to a secured information handling system. In such instances, the security analytics system 118 does not have user behavior baselines that may be compared with current user behaviors to determine whether the user's behavior at the protected endpoint 302 is anomalous. In certain embodiments, the endpoint initialization engine 312 collects historical usage data indicative of user behaviors occurring at the protected endpoint 302 prior to the time that the protected endpoint 302 is initially added to the secured information handling system.

In certain embodiments, the endpoint initialization engine 312 accesses the historical usage data stored in the protected endpoint 302 . In certain embodiments, the historical usage data is retrieved and formatted by the endpoint initialization engine 312 to generate one or more user behavior baselines that are communicated to the security analytics system 118 for use by the behavior initialization engine 130. In certain embodiments, the historical usage data stored on the protected endpoint 302 is retrieved by the endpoint initialization engine 312 and communicated to the security analytics system 118 as raw data (e.g., data that has not yet been processed to generate user behavior baselines in a format that is directly usable by the security analytics system 118). In certain embodiments, the behavior initialization engine 130 generates one or more user behavior baselines from the raw data communicated from the endpoint initialization engine 312 to place the user behavior baselines in a format that is suitable for use by the security analytics system 118. In some embodiments, certain user behavior baselines may be generated at the endpoint initialization engine 312, while other behavior baselines may be generated at the behavior initialization engine 130.

Additionally, or on the alternative, the endpoint initialization engine 312 may be invoked when a new security analytics feature that uses a previously unused user behavior is added to the security analytics system 118 of the secured information handling system. In such instances, user behavior baselines for the previously unused user behavior may be generated using the historical usage data stored at the protected endpoint 302.

In certain embodiments, a particular pluggable feature pack 308 is invoked as needed by the endpoint agent 306 to provide a given functionality. In certain embodiments, individual features of a particular pluggable feature pack 308 are invoked as needed. In certain embodiments, the endpoint initialization engine 312 may be implemented as a pluggable feature pack 308. In certain embodiments, a pluggable feature pack 308 may employ user behavior baselines that are instantiated for the behavior when the pluggable feature pack 308 is added to the protected endpoint 302.

It will be appreciated that the ability to invoke individual features of a pluggable feature pack 308, without necessarily invoking all such features, will likely improve the operational efficiency of the endpoint agent 306 while simultaneously reducing operational overhead. Accordingly, the endpoint agent 306 can self-optimize in certain embodiments by using the common infrastructure and invoking only those pluggable components that are applicable or needed for a given user behavior.

In certain embodiments, the individual features of a pluggable feature pack 308 are invoked by the endpoint agent 306 according to the occurrence of a particular user behavior. In certain embodiments, the individual features of a pluggable feature pack 308 are invoked by the endpoint agent 306 according to the occurrence of a particular temporal event, described in greater detail herein. In certain embodiments, the individual features of a pluggable feature pack 308 are invoked by the endpoint agent 306 at a particular point in time. In these embodiments, the method by which a given user behavior, temporal event, or point in time is selected is a matter of design choice.

In certain embodiments, the individual features of a pluggable feature pack 308 may be invoked by the endpoint agent 306 according to the context of a particular user behavior. As an example, the context may be the user enacting the user behavior, their associated risk classification, which resource they may be requesting, the point in time the user behavior is enacted, and so forth. In certain embodiments, the pluggable feature packs 308 may be sourced from various cloud services 206. In certain embodiments, the pluggable feature packs 308 may be dynamically sourced from various cloud services 206 by the endpoint agent 306 on an as-need basis.

In certain embodiments, the endpoint agent 306 may be implemented with additional functionalities, such as event analytics 310. In certain embodiments, the event analytics 310 functionality may include analysis of various user behaviors, described in greater detail herein. In certain embodiments, the endpoint agent 306 may be implemented with a thin hypervisor 314, which can be run at Ring -1, thereby providing protection for the endpoint agent 306 in the event of a breach. As used herein, a thin hypervisor broadly refers to a simplified, OS-dependent hypervisor implemented to increase security. As likewise used herein, Ring -1 broadly refers to approaches allowing guest operating systems to run Ring 0 (i.e., kernel) operations without affecting other guests or the host OS. Those of skill in the art will recognize that many such embodiments and examples are possible. Accordingly, the foregoing is not intended to limit the spirit, scope or intent of the invention.

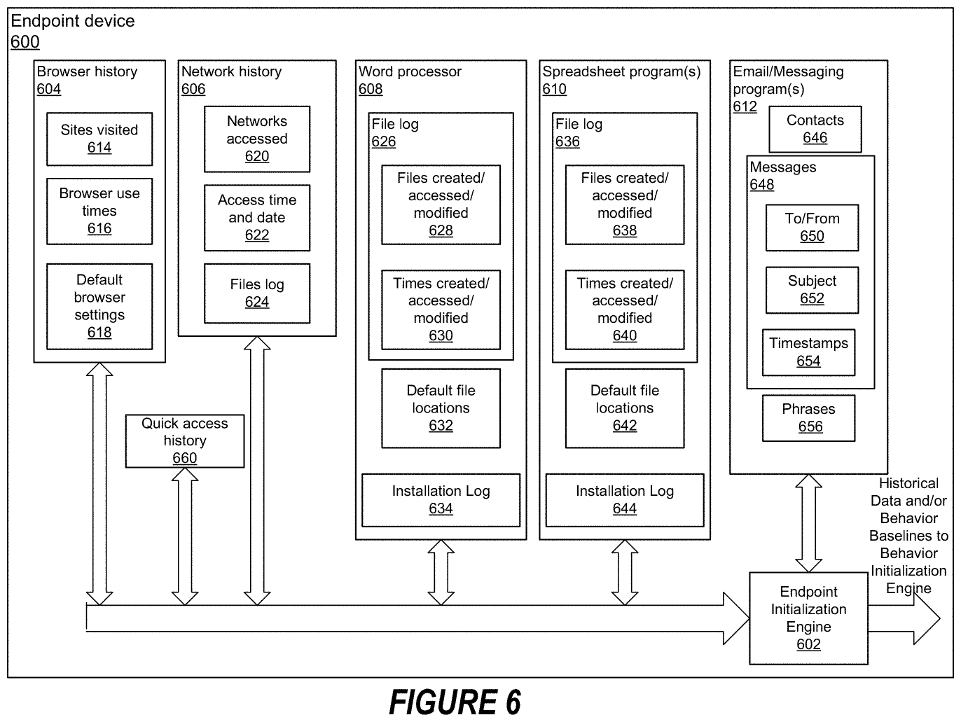

FIG. 4 is a simplified block diagram of a security analytics system implemented in certain embodiments of the disclosed system. In certain embodiments, the security analytics system 118 shown in FIG. 4 may include an event queue analytics 404 module, described in greater detail herein. In certain embodiments, the event queue analytics 404 sub-system may be implemented to include an enrichment 406 module and a streaming analytics module 408. In certain embodiments, the security analytics system 118 may be implemented to provide log storage, reporting, and analytics capable of performing streaming 408 and on-demand 410 analytics operations. In certain embodiments, such operations may be associated with defining and managing an adaptive trust profile (ATP), detecting entity behavior that may be of analytic utility, adaptively responding to mitigate risk, or a combination thereof. In certain embodiments, entity behavior of analytic utility may be determined to be anomalous, abnormal, unexpected, malicious, or some combination thereof.

In certain embodiments, the security analytics system 118 may be implemented to provide a uniform platform for storing events and contextual information associated with various entity behaviors and performing longitudinal analytics. As used herein, longitudinal analytics broadly refers to performing analytics of entity behaviors occurring over a particular period of time. As an example, an entity may iteratively attempt to access certain proprietary information stored in various locations. In addition, the attempts may occur over a brief period of time. To continue the example, the fact that the information the entity is attempting to access is proprietary, that it is stored in various locations, and the attempts are occurring in a brief period of time, in combination, may indicate the entity behavior enacted by the entity is suspicious. As another example, certain entity identifier information (e.g., a username) associated with an entity may change over time. In this example, a change in the entity's username, during a particular period of time or at a particular point in time, may represent suspicious entity behavior.

In certain embodiments, the security analytics system 118 may be implemented to be scalable. In certain embodiments, the security analytics system 118 may be implemented in a centralized location, such as a corporate data center. In these embodiments, additional resources may be added to the security analytics system 118 as needs grow. In certain embodiments, the security analytics system 118 may be implemented as a distributed system. In these embodiments, the security analytics system 118 may span multiple information handling systems. In certain embodiments, the security analytics system 118 may be implemented in a cloud environment. In certain embodiments, the security analytics system 118 may be implemented in a virtual machine (VM) environment. In such embodiments, the VM environment may be configured to dynamically and seamlessly scale the security analytics system 118 as needed. Skilled practitioners of the art will recognize that many such embodiments are possible. Accordingly, the foregoing is not intended to limit the spirit, scope or intent of the invention.

In certain embodiments, an event stream collector 402 may be implemented to collect event and related contextual information, described in greater detail herein, associated with various entity behaviors. In these embodiments, the method by which the event and contextual information are selected to be collected by the event stream collector 402 is a matter of design choice. In certain embodiments, the event and contextual information collected by the event stream collector 402 may be processed by an enrichment module 406 to generate enriched entity behavior information. In certain embodiments, the enrichment may include certain contextual information related to a particular entity behavior or event. In certain embodiments, the enrichment may include certain temporal information, such as timestamp information, related to a particular entity behavior or event.

In certain embodiments, enriched entity behavior information may be provided by the enrichment module 406 to a streaming 408 analytics module. In turn, the streaming 408 analytics module may provide some or all of the enriched entity behavior information to an on-demand 410 analytics module. As used herein, streaming 408 analytics broadly refers to analytics performed in near real-time on enriched entity behavior information as it is received. Likewise, on-demand 410 analytics broadly refers herein to analytics performed, as they are requested, on enriched entity behavior information after it has been received. In certain embodiments, the enriched entity behavior information may be associated with a particular event. In certain embodiments, the enrichment 406 and streaming analytics modules 408 may be implemented to perform event queue analytics 404 operations.

In certain embodiments, the on-demand 410 analytics may be performed on enriched entity behavior associated with a particular interval of, or point in time. In certain embodiments, the streaming 408 or on-demand 410 analytics may be performed on enriched entity behavior associated with a particular user, group of users, one or more non-user entities, or a combination thereof In certain embodiments, the streaming 408 or on-demand 410 analytics may be performed on enriched entity behavior associated with a particular resource, such as a facility, system, datastore, or service. Those of skill in the art will recognize that many such embodiments are possible. Accordingly, the foregoing is not intended to limit the spirit, scope or intent of the invention.

In certain embodiments, the results of various analytics operations performed by the streaming 408 or on-demand 410 analytics modules may be provided to a storage Application Program Interface (API) 414. In turn, the storage API 414 may be implemented to provide access to various datastores ‘1’ 416 through ‘n’ 418, which in turn are used to store the results of the analytics operations. In certain embodiments, the security analytics system 118 may be implemented with a logging and reporting front-end 412, which is used to receive the results of analytics operations performed by the streaming 408 analytics module. In certain embodiments, the datastores ‘1’ 416 through ‘n’ 418 may variously include a datastore of entity identifiers, temporal events, or a combination thereof.

In certain embodiments, the security analytics system 118 may include a risk scoring module 420 implemented to perform risk scoring operations, described in greater detail herein. In certain embodiments, functionalities of the risk scoring module 420 may be provided in the form of a risk management service 422. In certain embodiments, the risk management service 422 may be implemented to perform operations associated with defining and managing an adaptive trust profile (ATP). In certain embodiments, the risk management service 422 may be implemented to perform operations associated with detecting entity behavior that may be of analytic utility and adaptively responding to mitigate risk. In certain embodiments, the risk management service 422 may be implemented to provide the results of various analytics operations performed by the enrichment 406 or streaming analytics module 408. In certain embodiments, the risk management service 422 may be implemented to use the storage API 414 to access various enhanced cyber behavior and analytics information stored on the datastores ‘1’ 414 through ‘n’ 416. Skilled practitioners of the art will recognize that many such embodiments are possible. Accordingly, the foregoing is not intended to limit the spirit, scope or intent of the invention.

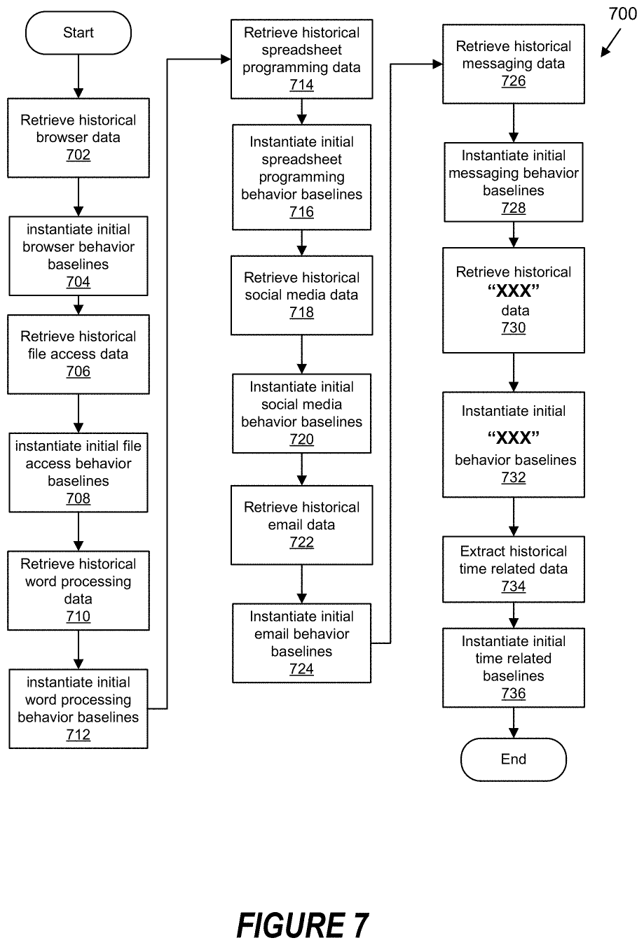

FIG. 5 is a simplified block diagram of the operation of a security analytics system implemented in accordance with an embodiment of the disclosed system. In certain embodiments, the security analytics system 118 may be implemented to perform operations associated with detecting entity behavior that may be of analytic utility. In certain embodiments, the security analytics system 118 may be implemented in combination with one or more endpoint agents 306, one or more edge devices 202, various cloud services 206, and a network 140 to perform such operations.

In certain embodiments, the network edge device 202 may be implemented in a bridge, a firewall, or a passive monitoring configuration. In certain embodiments, the edge device 202 may be implemented as software running on an information handling system. In certain embodiments, the network edge device 202 may be implemented to provide integrated logging, updating and control. In certain embodiments, the edge device 202 may be implemented to receive network requests and context-sensitive user behavior information in the form of enriched user behavior information 510, described in greater detail herein, from an endpoint agent 306, likewise described in greater detail herein.

In certain embodiments, the security analytics system 118 may be implemented as both a source and a sink of user behavior information. In certain embodiments, the security analytics system 118 may be implemented to serve requests for user/resource risk data. In certain embodiments, the edge device 202 and the endpoint agent 306, individually or in combination, may provide certain entity behavior information to the security analytics system 118 using either push or pull approaches familiar to skilled practitioners of the art.

As described in greater detail herein, the edge device 202 may be implemented in certain embodiments to receive enriched user behavior information 510 from the endpoint agent 306. It will be appreciated that such enriched user behavior information 510 will likely not be available for provision to the edge device 202 when an endpoint agent 306 is not implemented for a corresponding endpoint device 304. However, the lack of such enriched user behavior information 510 may be accommodated in various embodiments, albeit with reduced functionality related to operations associated with defining and managing an entity profile, detecting entity behavior that may be normal or of analytic utility, mitigating associated risk, or a combination thereof.

In certain embodiments, a given user behavior may be enriched by an associated endpoint agent 306 attaching contextual information to a request. In certain embodiments, the context is embedded within a network request, which is then provided as enriched user behavior information 510. In certain embodiments, the contextual information may be concatenated or appended to a request, which in turn may be provided as enriched user behavior information 510. In these embodiments, the enriched user behavior information 510 may be unpacked upon receipt and parsed to separate the request and its associated contextual information. Certain embodiments of the disclosed system reflect an appreciation that one possible disadvantage of such an approach is that it may perturb certain Intrusion Detection System and/or Intrusion Detection Prevention (IDS/IDP) systems implemented on a network 140.

In certain embodiments, new flow requests may be accompanied by a contextual information packet sent to the edge device 202. In these embodiments, the new flow requests may be provided as enriched user behavior information 510. In certain embodiments, the endpoint agent 306 may also send updated contextual information to the edge device 202 once it becomes available. As an example, an endpoint agent 306 may share a list of files that have been read by a current process at any point in time once the information has been collected. To continue the example, such a list of files may be used to determine which data the endpoint agent 306 may be attempting to exfiltrate.

In certain embodiments, point analytics processes executing on the edge device 202 may request a particular service. As an example, risk scores associated with a particular event on a per-user basis may be requested. In certain embodiments, the service may be requested from the security analytics system 118. In certain embodiments, the service may be requested from various cloud services 206.

In certain embodiments, contextual information associated with a particular entity behavior may be attached to various network service requests. In certain embodiments, the request may be wrapped and then handled by proxy. In certain embodiments, a small packet of contextual information associated with an entity behavior may be sent with a service request. In certain embodiments, service requests may be related to Domain Name Service (DNS), web browsing activity, email, and so forth, all of which are essentially requests for service by an endpoint device 304. In certain embodiments, such service requests may be associated with temporal event information, described in greater detail herein. Consequently, such requests can be enriched by the addition of entity behavior contextual information (e.g., UserAccount, interactive/automated, data-touched, temporal event information, etc.). Accordingly, the edge device 202 can then use this information to manage the appropriate response to submitted requests.

In certain embodiments, the security analytics system 118 may be implemented in different operational configurations. In certain embodiments, the security analytics system 118 may be implemented by using the endpoint agent 306. In certain embodiments, the security analytics system 118 may be implemented by using endpoint agent 306 in combination with the edge device 202. In certain embodiments, the cloud services 206 may likewise be implemented for use by the endpoint agent 306, the edge device 202, and the security analytics system 118, individually or in combination. In these embodiments, the security analytics system 118 may be primarily oriented to performing risk assessment operations related to entity actions, software program actions, data accesses, or a combination thereof. In certain embodiments, software program actions may be treated as a proxy for the entity.

In certain embodiments, the endpoint agent 306 may be implemented to update the security analytics system 118 with user behavior and associated contextual information, thereby allowing an offload of certain analytics processing overhead. In certain embodiments, this approach allows for longitudinal risk scoring, which assesses risk associated with certain user behavior during a particular interval of time. In certain embodiments, the security analytics system 118 may be implemented to access risk scores associated with the same user account, but accrued on different endpoint devices 304. It will be appreciated that such an approach may prove advantageous when an adversary is “moving sideways” through a network environment, using different endpoint devices 304 to collect information.

In certain embodiments, the security analytics system 118 may be primarily oriented to applying risk mitigations in a way that maximizes security effort return-on-investment (ROI). In certain embodiments, this approach may be accomplished by providing additional contextual and entity behavior information associated with entity requests. As an example, a web gateway may not concern itself with why a particular file is being requested by a certain entity at a particular point in time. Accordingly, if the file cannot be identified as malicious or harmless, there is no context available to determine how, or if, to proceed. To extend the example, the edge device 202 and security analytics system 118 may be coupled such that requests can be contextualized and fitted into a framework that evaluates their associated risk. Certain embodiments of the disclosed system reflect an appreciation that such an approach works well with web-based data loss protection (DLP) approaches, as each transfer is no longer examined in isolation, but in the broader context of an identified entity's actions, at a particular time, on the network 140.

As another example, the security analytics system 118 may be implemented to perform risk scoring processes to decide whether to block or allow unusual flows. In various embodiments, the risk scoring processes may be implemented to include certain aspects of eXtensible Access Control Markup Language (XACML) approaches known to skilled practitioners of the art. In certain embodiments, XACML obligations may be implemented to block or allow unusual flows. In certain embodiments, an XACML obligation may be implemented as a directive from a policy decision point (PDP) to a policy enforcement point (PEP) regarding what must be performed before or after a flow is approved. Certain embodiments of the disclosed system reflect an appreciation that such an approach is highly applicable to defending against point-of-sale (POS) malware, a breach technique that has become increasingly more common in recent years. Certain embodiments of the disclosed system likewise reflect an appreciation that while various edge device 202 implementations may not stop all such exfiltrations, they may be able to complicate the task for the attacker.

In certain embodiments, the security analytics system 118 may be primarily oriented to maximally leverage contextual information associated with various entity behaviors within the system. In certain embodiments, data flow tracking is performed by one or more endpoint agents 306, which allows the quantity and type of information associated with particular hosts to be measured. In turn, this information may be used to determine how the edge device 202 handles requests. By contextualizing such entity behavior on the network 140, the security analytics system 118 can provide intelligent protection, making decisions that make sense in the broader context of an organization's activities. Certain embodiments of the disclosed system reflect an appreciation that one advantage to such an approach is that information flowing through an organization, and the networks they employ, should be trackable, and substantial data breaches preventable. Skilled practitioners of the art will recognize that many such embodiments and examples are possible. Accordingly, the foregoing is not intended to limit the spirit, scope or intent of the invention.

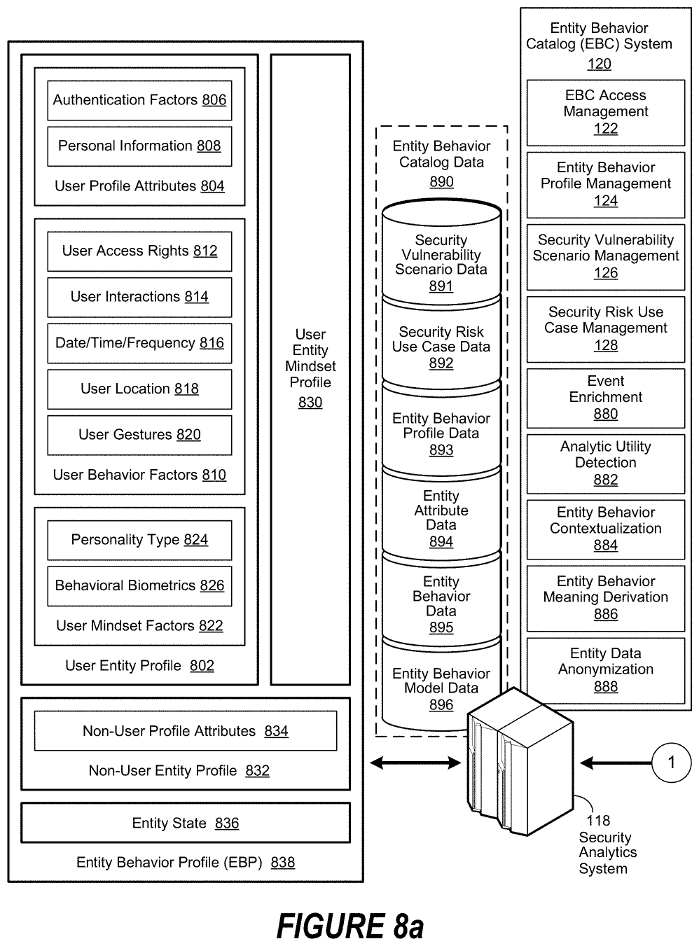

FIG. 6 shows components of an endpoint device 600 in which historical data is retrieved by an endpoint initialization engine 602 to instantiate a set of user behavior baselines that may be employed at the security analytics system 118. In the specific example shown in FIG. 6, the endpoint device 600 has been used by a user prior to the installation of the endpoint device 600 on the secured information handling system. Accordingly, the endpoint device 600 includes historical data indicative of how the endpoint device 600 was employed by the user prior to the installation. In certain embodiments, the historical data may include browser history data 604, network history data 606, word processor history data 608, spreadsheet program history data 610, and/or email/messaging data 612. The endpoint initialization engine 602 is configured to access the stored historical data to instantiate a set of baseline user behaviors at the endpoint device 600 or otherwise transmit the stored historical data as raw data to the security analytics system 118, which uses the raw data to generate a set of baseline user behaviors.

In certain embodiments, the browser history data 604 includes information relating to the user's interaction with a web browser. In the specific example shown in FIG. 6, the browser history data 604 may include a history of the sites visited by the user 614. The history of the sites visited by the user 614 may be used to generate a browser behavior baseline indicative of the sites that the user typically accesses. In certain embodiments, the sites that the user typically accesses may be compared against sites that are already considered to be malicious or otherwise undesirable and used as an indicator of potential misuse of the endpoint device 600 by the user. In certain embodiments, the sites that the user typically accesses may be compared against sites that the user is currently accessing to identify novel accesses of new sites not previously accessed.

In certain embodiments, the browser history data 604 includes browser use times 616. Browser use times 616 may be used to establish a time-based baseline behavior indicative of the times at which the user typically accesses the Internet and/or specific sites. Attempts to access the Internet and/or specific sites outside the established time-based baseline behavior may indicate that the user is engaging in anomalous user behavior.

In certain embodiments, the browser history data 604 includes default browser settings 618. The content of the home page designated in the default browser settings 618 may be indicative of the mindset of the user (e.g., radical news site, comedy news site, business news site, personal website, etc.) The default browser settings may also data to establish a baseline for security settings employed by the user. Attempts by the user to change the security settings from the baseline may indicate that the user is engaging in anomalous behavior (e.g., attempting to avoid firewalls, attempting to allow installation of unauthorized browser add-ons, etc.).

In certain embodiments, the network history data 606 includes information relating to networks accessed by the user at the endpoint device 600. In certain embodiments, the historical data may include a list of the IP addresses or other information 620 identifying the networks accessed. In certain embodiments, the historical data may be used to instantiate a baseline behavior indicating which networks are typically accessed by the user. Access of a new network not included in the baseline behavior may be indicative of anomalous user behavior that, for example, may be flagged and/or interrupted.

In certain embodiments, the network history data 606 includes time-based data 622 corresponding to the dates, days of the week, times, durations of general network usage. In certain embodiments, the time-based data 622 includes data corresponding to the dates, days of the week, times, durations of usage of specific networks. Such time-based historical data may be used to instantiate a time-based baseline user behavior, which may be used to indicate whether a user is accessing a network at an unusual time that differs from the regular use times.

In certain embodiments, the network history data 606 includes a file log 624 having a list of files that have been accessed when the user is connected to a network. The file log 624 may include the names of files 628 that have been created, accessed, or modified by the user and the times 630 that the files were created, accessed, or modified. The names of the files 628 and times 630 may be used to establish a user behavior baseline for the use of the word processing program. Deviations from the times at which the user regularly uses the word processor may indicate anomalous user behavior. Deviations from the type of engagement (e.g., file creation, file access, file modification, etc.) that the user regularly exhibits may indicate anomalous user behavior. Attempts to access or modify a new file not included in the file log 626 may indicate anomalous user behavior.

In certain embodiments, the word processor history data 608 may be used to instantiate user behavior baselines for the use of a word processing program. In certain embodiments, the word processor history data 608 may include a file log 626. In certain embodiments, the file log includes a list of files 628 created, accessed, or modified by the user, as well as a corresponding list of the times 630 that files were created, accessed, or modified. The user behavior baseline may be used to determine, for example, whether the user is accessing a file that is not usually accessed by the user, engaging in particular user activities (e.g., modifying files, deleting files, etc.), using the word processing program at an unusual time, accessing certain files at an unusual time, etc. Deviations from the user behavior baseline may indicate anomalous user behavior.

In certain embodiments, the word processor history data 608 includes information on the default locations for saving a file, file templates, etc., in a default file locations log 632. Certain embodiments may use the information in the default file locations log 632 to establish a user behavior baseline for regular operation of the word processor by the user. In certain embodiments, attempts to change the default file locations may indicate anomalous user behavior.

In certain embodiments, the word processor history data 608 may include an installation log 634 generated when the word processor was initially installed on the endpoint device 600. The installation log 634 may be used to establish a user behavior baseline for the installation. In certain embodiments, any attempt to reinstall the word processor program may be compared with the user behavior baseline for the original installation to determine whether the reinstallation constitutes anomalous user behavior.

In certain embodiments, the spreadsheet program history data 610 may be used to instantiate user behavior baselines for the use of a spreadsheet program. In certain embodiments, the spreadsheet program history data 610 may include a file log 636. In certain embodiments, the file log 636 includes a list of files 638 created, accessed, or modified by the user, as well as a corresponding list of the times 640 that files were created, accessed, or modified. The user behavior baseline may be used to determine, for example, whether the user is accessing a spreadsheet that is not usually accessed by the user, whether the user is engaged in particular user activities (e.g., modifying files, deleting files, etc.), whether the user is using the spreadsheet program at an unusual time, accessing certain spreadsheets at an unusual time, etc. Deviations from the user behavior baseline derived from the spreadsheet program history data 610 may indicate anomalous user behavior.

In certain embodiments, the spreadsheet program history data 610 includes a default file locations log 642 storing the information on the default locations for saving a file, file templates, etc. Certain embodiments may use the information in the default file locations log 642 to establish a user behavior baseline for regular operation of the spreadsheet program by the user. In certain embodiments, attempts to change the default file locations may indicate anomalous user behavior.

In certain embodiments, the spreadsheet program history data 610 includes an installation log 644 generated when the spreadsheet application was initially installed on the endpoint device 600. The installation log 644 may be used to establish a user behavior baseline for the installation. In certain embodiments, any attempt to reinstall the spreadsheet program may be compared with the user behavior baseline for the original installation to determine whether the reinstallation constitutes anomalous user behavior.

In certain embodiments, the email/messaging data 612 may be used to instantiate a user behavior baseline for user communications with other individuals/entities. In certain embodiments, the email/messaging data 612 includes a list of contacts 646 and a list of historical messages 648. In certain embodiments, the messages 648 include to/from data 650 corresponding to the sending and receiving entities, message subjects 652 as found in the message headers, and message timestamps 654 as found in the message headers. Certain embodiments may also include a table of phrases 656 extracted from the text of the messages. In certain embodiments, the table of phrases 656 may be generated by the email/messaging program. Additionally, on the alternative, the table of phrases may be generated by the endpoint initialization engine 602. The contacts data 646, messages data 648, and/or table of phrases 656 may be used to instantiate a user behavior baseline that, in turn, may be compared to current email/messaging activities of the user to identify potentially anomalous user behavior.

Certain endpoint devices 600 execute operating systems that allow quick access to files, programs, websites, networks, etc. Such endpoint devices may include a quick access history 660. The quick access history 660 may also be used to instantiate user behavior baselines for quick access items.

FIG. 6 has been described in a manner in which historical data for individual programs is used to instantiate user baselines for the corresponding programs. However, it will be recognized, based on the teachings of the present disclosure, that historical data retrieved from multiple programs may be used to instantiate user behavior baselines that are not specifically unique to any individual program. Rather, historical data from multiple programs may be used to instantiate composite user baseline behaviors incorporating aspects of historical data retrieved from multiple sources. As such, FIG. 6 depicts non-limiting examples of the types of historical data that may be used to instantiate user behavior baselines on the endpoint device 600.

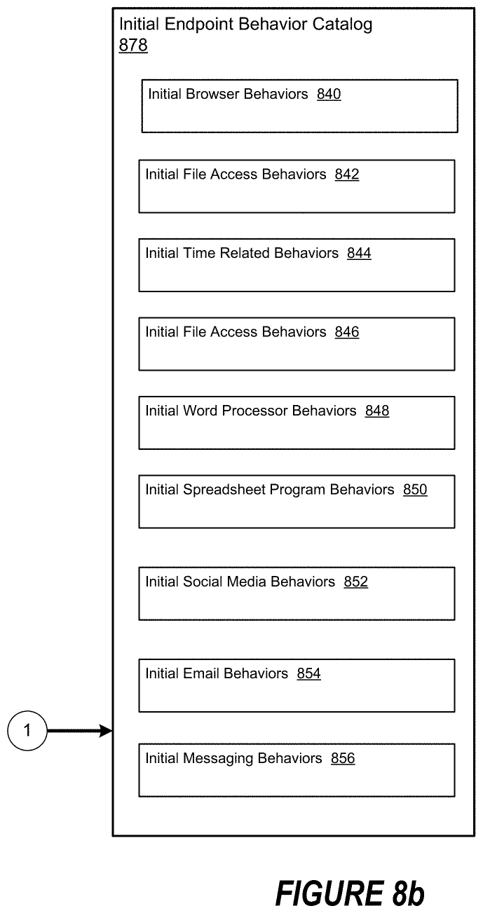

FIG. 7 shows a flowchart 700 of exemplary operations that may be executed in certain embodiments of the disclosed system to instantiate user behavior baselines. In the specific example shown in FIG. 7, historical browser data is retrieved at operation 702, and initial browser behavior baselines are instantiated at operation 704. Historical file access data is retrieved at operation 706, and initial file accessed behavior baselines are generated at 708. Historical word processing data may be retrieved at operation 710 and used to instantiate corresponding user behavior baselines at operation 712. Historical spreadsheet programming data may be retrieved at operation 714 and used to instantiate corresponding user behavior baselines at operation 716. Historical social media data may be retrieved at operation 718 and used to instantiate corresponding user behavior baselines at operation 720. Historical email data may be retrieved at operation 722 and used to instantiate initial email behavior baselines at operation 724. Historical messaging data may be retrieved at operation 726, and corresponding user behavior baselines may be instantiated at operation 728.

User behavior baselines may be instantiated from other types of historical data, shown here as “XXX.” As such, in certain embodiments, historical data may be retrieved for each XXX at operation 730, and corresponding user behavior baselines may be instantiated at operation 732. Further, in certain embodiments, the historical time-related data may be retrieved from all or a subset of programs at operation 734 and used to instantiate corresponding initial time-related baselines at operation 736.

FIG. 7 has been described in a manner in which historical data for individual programs is used to instantiate user baselines for the corresponding programs. However, it will be recognized, based on the teachings of the present disclosure, that historical data retrieved from multiple programs may be used to instantiate user behavior baselines that are not unique to any individual program. Rather, historical data from multiple programs may be used to instantiate composite user baseline behaviors incorporating aspects of historical data retrieved from multiple sources. As such, FIG. 7 depicts non-limiting examples of the types of historical data that may be used to instantiate user behavior baselines on the endpoint device.

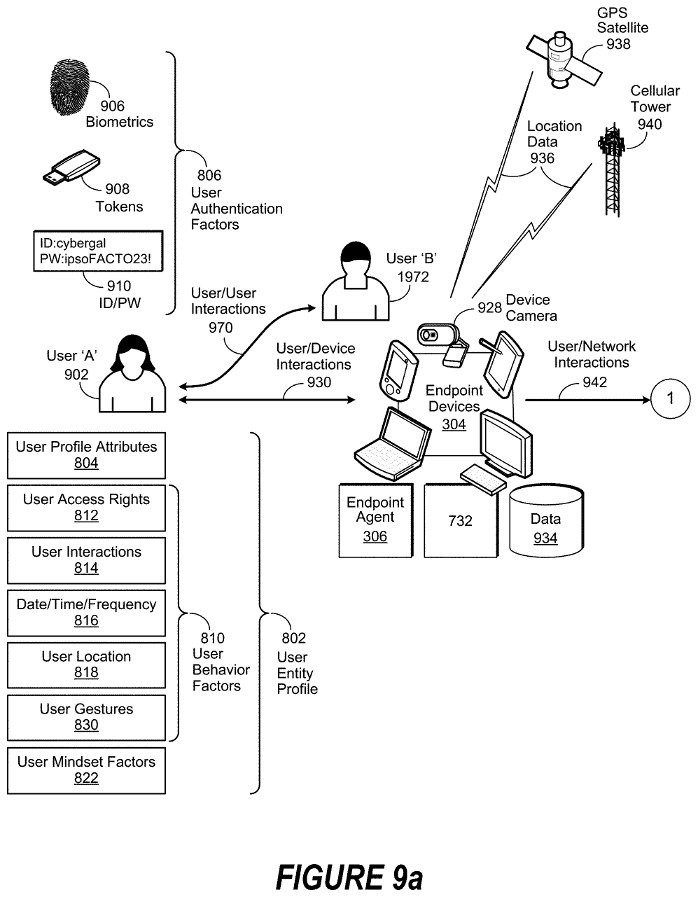

FIGS. 8a and 8b show a simplified block diagram of an entity behavior profile (EBP) and a set of user behaviors baselines instantiated from historical data stored on an endpoint device. As used herein, an entity behavior profile 838 broadly refers to a collection of information that uniquely describes a particular entity's identity and their associated behavior, whether the behavior occurs within a physical realm or cyberspace. In certain embodiments, an EBP 838 may be used to adaptively draw inferences regarding the trustworthiness of a particular entity. In certain embodiments, the drawing of the inferences may involve comparing a new entity behavior to known past behaviors enacted by the entity. In certain embodiments, new entity behavior of analytic utility may represent entity behavior that represents a security risk. As likewise used herein, an entity broadly refers to something that exists as itself, whether physically or abstractly. In certain embodiments, an entity may be a user entity, a non-user entity, or a combination thereof In certain embodiments, the identity of an entity may be known or unknown.

As used herein, a user entity broadly refers to an entity capable of enacting a user entity behavior. Examples of a user entity include an individual person, a group of people, an organization, or a government. As likewise used herein, a non-user entity broadly refers to an entity whose identity can be described and may exhibit certain behavior but is incapable of enacting a user entity behavior. Examples of a non-user entity include an item, a device, such as endpoint and edge devices, a network, an account, a domain, an operation, a process, and an event. Other examples of a non-user entity include a resource, such as a geographical location or formation, a physical facility, a venue, a system, a software application, a data store, and a service, such as a service operating in a cloud environment.

Certain embodiments of the disclosed system reflect an appreciation that being able to uniquely identity a device may assist in establishing whether or not a particular login is legitimate. As an example, user impersonations may not occur at the user's endpoint, but instead, from another device or system. Certain embodiments of the disclosed system likewise reflect an appreciation that profiling the entity behavior of a particular device or system may assist in determining whether or not it is acting suspiciously.

In certain embodiments, an account may be a local account, which runs on a single machine. In certain embodiments, an account may be a global account, providing access to multiple resources. In certain embodiments, a process may be implemented to run in an unattended mode, such as when backing up files or checking for software updates. Certain embodiments of the disclosed system reflect an appreciation that it is often advantageous to track events at the process level as a method of determining which events are associated with background processes and which are initiated by a user entity.

In certain embodiments, an EBP 838 may be implemented to include a user entity profile 802, an associated user entity mindset profile 830, a non-user entity profile 832, and an entity state 836. As used herein, a user entity profile 802 broadly refers to a collection of information that uniquely describes a user entity's identity and their associated behavior, whether the behavior occurs within a physical realm or cyberspace. In certain embodiments, the user entity profile 802 may include user profile attributes 804, user behavior factors 810, user mindset factors 822, or a combination thereof In certain embodiments, the user profile attributes 804 may include certain user authentication factors 806, described in greater detail herein, and personal information 808.

As used herein, a user profile attribute 804 broadly refers to data or metadata that can be used, individually or in combination with other user profile attributes 804, user behavior factors 810, or user mindset factors 822, to ascertain the identity of a user entity. In various embodiments, certain user profile attributes 804 may be uniquely associated with a particular user entity. In certain embodiments, the personal information 808 may include non-sensitive personal information associated with a user entity, such as their name, title, position, role, and responsibilities. In certain embodiments, the personal information 808 may likewise include technical skill level information, peer information, expense account information, paid time off (PTO) information, data analysis information, insider information, misconfiguration information, third party information, or a combination thereof In certain embodiments, the personal information 808 may contain sensitive personal information associated with a user entity. As used herein, sensitive personal information (SPI), also commonly referred to as personally identifiable information (PII), broadly refers to any information usable to ascertain the identity of a user entity, either by itself, or in combination with other information, such as contextual information described in greater detail herein.

Examples of SPI may include the full or legal name of a user entity, initials or nicknames, place and date of birth, home and business addresses, personal and business telephone numbers, their gender, and other genetic information. Additional examples of SPI may include government-issued identifiers, such as a Social Security Number (SSN) or a passport number, vehicle registration plate and serial numbers, and driver's license numbers. Other examples of SPI may include certain email addresses and social media identifiers, credit and debit card numbers, and other digital identity information. Yet other examples of SPI may include employer-issued identifiers, financial transaction information, credit scores, electronic medical records (EMRs), insurance claim information, personal correspondence, and so forth. Further examples of SPI may include user authentication factors 806, such as biometrics, user identifiers and passwords, and personal identification numbers (PINs).

In certain embodiments, the SPI may include information considered by an individual user, a group of users, or an organization (e.g., a company, a government or non-government organization, etc.), to be confidential or proprietary. One example of such confidential information is protected health information (PHI). As used herein, PHI broadly refers to any information associated with the health status, provision of health care, or payment for health care that is created or collected by a “covered entity,” or an associate thereof, that can be linked to a particular individual. As used herein, a “covered entity” broadly refers to health plans, healthcare clearinghouses, healthcare providers, and others, who may electronically communicate any health-related information associated with a particular individual. Examples of such PHI may include any part of a patient's medical record, healthcare record, or payment history for medical or healthcare services.

As used herein, a user behavior factor 810 broadly refers to information associated with a user entity's behavior, whether the behavior occurs within a physical realm or cyberspace. In certain embodiments, user behavior factors 810 may include the user entity's access rights 812, the user entity's interactions 814, and the date/time/frequency 816 of when the interactions 814 are enacted. In certain embodiments, the user behavior factors 810 may likewise include the user entity's location 818, and the gestures 820 used by the user entity to enact the interactions 814.

In certain embodiments, the user entity gestures 820 may include keystrokes on a keypad, a cursor movement, a mouse movement or click, a finger swipe, tap, or other hand gesture, an eye movement, or some combination thereof In certain embodiments, the user entity gestures 820 may likewise include the cadence of the user's keystrokes, the motion, force and duration of a hand or finger gesture, the rapidity and direction of various eye movements, or some combination thereof In certain embodiments, the user entity gestures 820 may include various audio or verbal commands performed by the user.

As used herein, user mindset factors 822 broadly refer to information used to make inferences regarding the mental state of a user entity at a particular point in time, during the occurrence of an event or an enactment of a user behavior, or a combination thereof. As likewise used herein, mental state broadly refers to a hypothetical state corresponding to the way a user entity may be thinking or feeling. Likewise, as used herein, an event broadly refers to the occurrence of an action performed by an entity. In certain embodiments, the user entity mindset factors 822 may include a personality type 824. Examples of known approaches for determining a personality type 824 include Jungian types, Myers-Briggs type indicators, Keirsey Temperament Sorter, Socionics, Enneagram of Personality, and Eyseneck's three-factor model.

In certain embodiments, the user mindset factors 822 may include various behavioral biometrics 826. As used herein, a behavioral biometric 828 broadly refers to a physiological indication of a user entity's mental state. Examples of behavioral biometrics 826 may include a user entity's blood pressure, heart rate, respiratory rate, eye movements and iris dilation, facial expressions, body language, tone and pitch of voice, speech patterns, and so forth.

Certain embodiments of the disclosed system reflect an appreciation that certain user behavior factors 810, such as user entity gestures 820, may provide additional information related to inferring a user entity's mental state. As an example, a user entering text at a quick pace with a rhythmic cadence may indicate intense focus. Likewise, an individual user intermittently entering text with forceful keystrokes may indicate the user is in an agitated state. As another example, the user may intermittently enter text somewhat languorously, which may indicate being in a thoughtful or reflective state of mind. As yet another example, the user may enter text with a light touch with an uneven cadence, which may indicate the user is hesitant or unsure of what is being entered.

Certain embodiments of the disclosed system likewise reflect an appreciation that while the user entity gestures 820 may provide certain indications of the mental state of a particular user entity, they may not provide the reason for the user entity to be in a particular mental state. Likewise, certain embodiments of the disclosed system include an appreciation that certain user entity gestures 820 and behavioral biometrics 826 are reflective of an individual user's personality type 824. As an example, aggressive, forceful keystrokes combined with an increased heart rate may indicate normal behavior for a particular user when composing end-of-month performance reviews. In various embodiments, certain user entity behavior factors 810, such as user gestures 820, may be correlated with certain contextual information.

In certain embodiments, a security analytics system 118 may be implemented to include an entity behavior catalog (EBC) system 120. In certain embodiments, the EBC system 120 may be implemented to generate, manage, store, or some combination thereof, information related to the behavior of an associated entity. In various embodiments, the EBC system 120 may be implemented as a cyber behavior catalog. In certain of these embodiments, the cyber behavior catalog may be implemented to generate, manage, store, or some combination thereof, information related to cyber behavior, described in greater detail herein, enacted by an associated entity. In various embodiments, as likewise described in greater detail herein, the information generated, managed, stored, or some combination thereof, by such a cyber behavior catalog, may be related to cyber behavior enacted by a user entity, a non-user entity, or a combination thereof.

In certain embodiments, the EBC system 120 may be implemented to use a user entity profile 802 in combination with an entity state 836 to generate a user entity mindset profile 830. As used herein, entity state 836 broadly refers to the context of a particular event or entity behavior. In certain embodiments, the entity state 836 may be a long-term entity state or a short-term entity state. As used herein, a long-term entity state 836 broadly relates to an entity state 836 that persists for an extended interval of time, such as six months or a year. As likewise used herein, a short-term entity state 836 broadly relates to an entity state 836 that occurs for a brief interval of time, such as a few minutes or a day. In various embodiments, the method by which an entity state's 836 associated interval of time is considered to be long-term or short-term is a matter of design choice.

As an example, a particular user may have a primary work location, such as a branch office, and a secondary work location, such as their company's corporate office. In this example, the user's primary and secondary offices respectively correspond to the user's location 818, whereas the presence of the user at either office corresponds to an entity state 836. To continue the example, the user may consistently work at their primary office Monday through Thursday, but at their company's corporate office on Fridays. To further continue the example, the user's presence at their primary work location may be a long-term entity state 836, while their presence at their secondary work location may be a short-term entity state 836. Accordingly, a date/time/frequency 816 user entity behavior factor 814 can likewise be associated with user behavior respectively enacted on those days, regardless of their corresponding locations. Consequently, the long-term user entity state 836 on Monday through Thursday will typically be “working at the branch office” and the short-term entity state 836 on Friday will likely be “working at the corporate office.”

As likewise used herein, a user entity mindset profile 830 broadly refers to a collection of information that reflects an inferred mental state of a user entity at a particular time during the occurrence of an event or an enactment of a user behavior. As an example, certain information may be known about a user entity, such as their name, their title and position, and so forth, all of which are user profile attributes 804. Likewise, it may be possible to observe a user entity's associated user behavior factors 810, such as their interactions with various systems, when they log-in and log-out, when they are active at the keyboard, the rhythm of their keystrokes, and which files they typically use.

Certain embodiments of the disclosed system reflect an appreciation these behavior factors 810 can be considered to be a behavioral fingerprint. In certain embodiments, the user behavior factors 810 may change, a little or a lot, from day to day. These changes may be benign, such as when a user entity begins a new project and accesses new data, or they may indicate something more concerning, such as a user entity who is actively preparing to steal data from their employer. In certain embodiments, the user behavior factors 810 may be implemented to ascertain the identity of a user entity. In certain embodiments, the user behavior factors 810 may be uniquely associated with a particular entity.

In certain embodiments, observed user behaviors may be used to build a user entity profile 802 for a particular user or other entity. In addition to creating a model of a user's various attributes and observed behaviors, these observations can likewise be used to infer things that are not necessarily explicit. Accordingly, in certain embodiments, a behavioral fingerprint may be used in combination with an EBP 838 to generate an inference regarding an associated user entity. As an example, a particular user may be observed eating a meal, which may or may not indicate the user is hungry. However, if it is also known that the user worked at their desk throughout lunchtime and is now eating a snack during a mid-afternoon break, then it can be inferred they are indeed hungry.

As likewise used herein, a non-user entity profile 832 broadly refers to a collection of information that uniquely describes a non-user entity's identity and their associated behavior, whether the behavior occurs within a physical realm or cyberspace. In various embodiments, the non-user entity profile 832 may be implemented to include certain non-user profile attributes 834. As used herein, a non-user profile attribute 834 broadly refers to data or metadata that can be used, individually or in combination with other non-user profile attributes 834, to ascertain the identity of a non-user entity. In various embodiments, certain non-user profile attributes 834 may be uniquely associated with a particular non-user entity.

In certain embodiments, the non-user profile attributes 834 may be implemented to include certain identity information, such as a non-user entity's network, Media Access Control (MAC), or physical address, its serial number, associated configuration information, and so forth. In various embodiments, the non-user profile attributes 834 may be implemented to include non-user behavior information associated with interactions between certain user and non-user entities, the type of those interactions, the data exchanged during the interactions, the date/time/frequency of such interactions, and certain services accessed or provided.

In certain embodiments, the EBC system 120 may be implemented to include an EBC access management 122, an EBP management 124, a security vulnerability scenario management module 126, a security risk use case management 128, an event enrichment 880, an analytic utility detection 882, an entity behavior contextualization module 884, an entity behavior meaning derivation module 886, and an entity data anonymization 888 module or a combination thereof In various embodiments, the EBC access management module 122 may be implemented to provide access to certain functionalities performed by the EBC system 120. In various embodiments, the EBP management module 124 may be implemented to perform certain EBP management operations, described in greater detail herein. In various embodiments, the security vulnerability scenario management module 126 may be implemented to perform certain security vulnerability scenario management operations, described in greater detail herein.

In various embodiments, the event enrichment 880 module may be implemented to perform certain event enrichment operations, described in greater detail herein. In various embodiments, the analytic utility detection 882 module may be implemented to perform certain analytic utility detection operations. In various embodiments, the entity behavior contextualization module 884 may be implemented to perform certain contextualization operations. As likewise described in greater detail herein, the entity behavior meaning derivation module 886 may be implemented in various embodiments to perform certain behavior meaning derivation operations. In certain embodiments, the entity data anonymization 888 module may be implemented various embodiments to perform certain data anonymization operations. In various embodiments, the EBC access management 122, EBP management 124, security vulnerability scenario management module 126, security risk use case management 128, event enrichment 880, analytic utility detection 882, entity behavior contextualization module 884, entity behavior meaning derivation module 886, and entity data anonymization 888 modules, or a combination thereof, may be implemented to provide an EBC reference architecture for performing certain EBC operations, described in greater detail herein.

In various embodiments, the EBC system 120 may be implemented to use certain data associated with an EBP 838 to derive an inference for contextualizing an electronically-observable behavior of a corresponding entity. In certain embodiments, the EBC system 120 may be implemented to use a user entity profile 802 in combination with a user entity mindset profile 832 and an associated entity state 836 to infer a user entity's intent. In certain embodiments, the EBP system 120 may be implemented to use various data stored in a repository of EBP data 890 to perform such an inference. In certain embodiments, the repository of EBP data 890 may include various EBPs 838, an initial endpoint behavior catalog 878, and associated contextual information, described in greater detail herein.

In various embodiments, the EBC system 120 may be implemented to use certain data associated with an EBP 838 to provide a probabilistic measure of whether a particular electronically-observable event is of analytic utility. In certain embodiments, an electronically-observable event that is of analytic utility may be determined to be anomalous, abnormal, unexpected, or malicious. To continue the prior example, a user may typically work out of their company's corporate office on Fridays. Furthermore, various user mindset factors 822 within their associated user entity profile 802 may indicate that the user is typically relaxed and methodical when working with customer data. Moreover, the user's user entity profile 802 indicates that such user interactions 814 with customer data typically occur on Monday mornings and the user rarely, if ever, copies or downloads customer data. However, the user may decide to interact with certain customer data late at night, on a Friday, while in their company's corporate office. As they do so, they exhibit an increased heart rate, rapid breathing, and furtive keystrokes while downloading a subset of customer data to a flash drive.

Consequently, their user entity mindset profile 830 may reflect a nervous, fearful, or guilty mindset, which is inconsistent with the entity state 836 of dealing with customer data in general. More particularly, downloading customer data late at night on a day the user is generally not in their primary office results in an entity state 836 that is likewise inconsistent with the user's typical user behavior. As a result, the EBC system 120 may infer that the user's behavior may represent a security threat. Those of skill in the art will recognize that many such embodiments and examples are possible. Accordingly, the foregoing is not intended to limit the spirit, scope or intent of the invention.

Certain embodiments of the disclosed system reflect an appreciation that the quantity and relevancy of information contained in a particular EBP 838 may have a direct bearing on its analytic utility when attempting to determine the trustworthiness of an associated entity and whether or not they represent a security risk. As used herein, the quantity of information contained in a particular EBP 838 broadly refers to the variety and volume of EBP elements it may contain, and the frequency of their respective instances, or occurrences, related to certain aspects of an associated entity's identity and behavior. As used herein, an EBP element broadly refers to any data element stored in an EBP 838. In various embodiments, an EBP element may be used to describe a particular aspect of an EBP, such as certain user profile attributes 804, user behavior factors 810, user mindset factors 822, user entity mindset profile 830, non-user profile attributes 834, and entity state 836.

In certain embodiments, statistical analysis may be performed on the information contained in a particular EBP 838 to determine the trustworthiness of its associated entity and whether or not they represent a security risk. For example, a particular authentication factor 806, such as a biometric, may be consistently used by a user entity for authenticating their identity to their endpoint device. To continue the example, a user ID and password may be used by the same, or a different, user entity, in an attempt to access the endpoint device. As a result, the use of a user ID and password may indicate a security risk due to its statistical infrequency. As another example, a user entity may consistently access three different systems on a daily basis in their role as a procurement agent. In this example, the three systems may include a financial accounting system, a procurement system, and an inventory control system. To continue the example, an attempt by the procurement agent to access a sales forecast system may appear suspicious if never attempted before, even if the purpose of accessing the system is legitimate.

As likewise used herein, the relevancy of information contained in a particular EBP 838 broadly refers to the pertinence of the EBP elements it may contain to certain aspects of an associated entity's identity and behavior. To continue the prior example, an EBP 838 associated with the procurement agent may contain certain user profile attributes 804 related to their title, position, role, and responsibilities, all of which may be pertinent to whether or not they have a legitimate need to access the sales forecast system. In certain embodiments, the user profile attributes 804 may be implemented to include certain job description information. To further continue the example, such job description information may have relevance when attempting to determine whether or not the associated entity's behavior is suspicious. In further continuance of the example, job description information related to the procurement agent may include their responsibility to check sales forecast data, as needed, to ascertain whether or not to procure certain items. In these embodiments, the method by which it is determined whether the information contained in a particular EBP 838 is of sufficient quantity and relevancy is a matter of design choice.

Various embodiments of the disclosed system likewise reflect an appreciation that accumulating sufficient information in an EBP 838 to make such a determination may take a certain amount of time. Likewise, various embodiments of the disclosed system reflect an appreciation that the effectiveness or accuracy of such a determination may rely upon certain entity behaviors occurring with sufficient frequency, or in identifiable patterns, or a combination thereof, during a particular period of time. As an example, there may not be sufficient occurrences of a particular type of entity behavior to determine if a new entity behavior is inconsistent with known past occurrences of the same type of entity behavior.

Certain embodiments recognize that the absence of data to establish baseline user behaviors may be problematic when an endpoint for the user is initially added to the secured information handling system. Accordingly, various embodiments of the disclosed system reflect an appreciation that a sparsely-populated EBP 838 may likewise result in exposure to certain security vulnerabilities. Various embodiments of the disclosed system likewise reflect an appreciation that an EBP 838 may be particularly sparsely populated when first implemented. Furthermore, the relevance of such sparsely-populated information initially contained in an EBP 838 first implemented may not prove very useful when using an EBP 838 to determine the trustworthiness of an associated entity and whether or not they represent a security risk. Accordingly, certain embodiments reflect an appreciation that the historical data on the endpoint device may be used to instantiate an initial endpoint behavior catalog 878, which provides a sufficient quantity of relevant information to improve the analytic utility of an EBP 838 when initially implemented. As used herein, an initial endpoint behavior catalog 878 broadly refers to a collection of information that generically describes a particular entity's expected behavior as derived from historical data stored on an endpoint device used by a user when the endpoint device is initially added to a secured network or when historical data is to be used to implement a new security analytics feature.

FIG. 8b depicts various user behavior profiles that may be instantiated in an initial endpoint behavior catalog 878 using historical data of an endpoint device. The exemplary initial behavior catalog 878 shown in this example includes initial browser behaviors 840, initial file access behaviors 842, initial time-related behaviors 844, initial file access behaviors 846, initial word processor behaviors 848, initial spreadsheet program behaviors 850, initial social media behaviors 852, initial email behaviors 854, and initial messaging behaviors 856. It will be recognized, based on the teachings of the present disclosure, that the foregoing user behaviors constitute non-limiting examples, and that a higher number or fewer number of instantiated user behaviors may be incorporated in the initial endpoint behavior catalog 878.

As shown in FIG. 8a, the user entity profile 802 of the EBP 838 may include certain user profile attributes 804, user behavior factors 810 and user mindset factors 822. Likewise, as shown in FIG. 8a, the user profile attributes 804 may include certain EBP elements related to authentication factors 806 and personal information 808. As likewise shown in FIG. 8a, the user behavior factors 810 may include certain EBP elements related to user access rights 812, user interactions 814, date/time/frequency 816, user location 818, and user gestures 820. Likewise, the user mindset factors 822 shown in FIG. 8a may include certain EBP elements related to personality type 824 and behavioral biometrics 826, while the non-user entity profile 832 may include certain EBP elements related to non-user profile attributes 834.

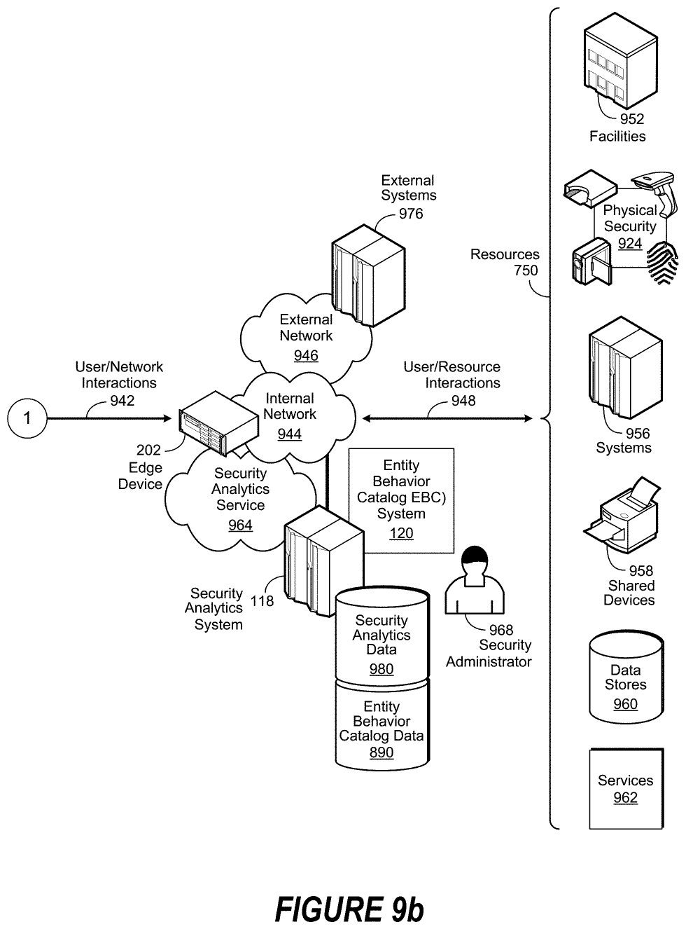

FIGS. 9a and 9b show a block diagram of a security analytics environment implemented in accordance with an embodiment of the disclosed system. In certain embodiments, a security analytics system 118 may be implemented with an entity behavior catalog (EBC) system 120, described in greater detail herein. In certain embodiments, analyses performed by the security analytics system 118 may be used to identify behavior associated with a particular entity that may be of analytic utility. In certain embodiments, as likewise described in greater detail herein, the EBC system 120 may be used in combination with the security analytics system 118 to perform such analyses. In various embodiments, certain data stored in a repository of security analytics data, or a repository of EBC data 890, or both, may be used by the security analytics system 118, or the EBC system 120, or both, to perform the analyses.

In certain embodiments, the entity behavior of analytic utility may be identified at a particular point in time, during the occurrence of an event, the enactment of a user or non-user entity behavior, or a combination thereof. As used herein, an entity broadly refers to something that exists as itself, whether physically or abstractly. In certain embodiments, an entity may be a user entity, a non-user entity, or a combination thereof. In certain embodiments, a user entity may be an individual user, such as user ‘A’ 902 or ‘B’ 972, a group, an organization, or a government. In certain embodiments, a non-user entity may likewise be an item, a device, such as endpoint 304 and edge devices 202, a network, such as an internal 944 and external 946 networks, a domain, an operation, or a process. In certain embodiments, a non-user entity may be a resource 950, such as a geographical location or formation, a physical facility 952, such as a venue, various physical security devices 954, a system 956, shared devices 958, such as printer, scanner, or copier, a data store 960, or a service 962, such as a service 962 operating in a cloud environment.

As likewise used herein, an event broadly refers to the occurrence of an action performed by an entity. In certain embodiments, the action may be directly associated with an entity behavior, described in greater detail herein. As an example, a first user may attach a binary file infected with a virus to an email that is subsequently sent to a second user. In this example, the act of attaching the binary file to the email is directly associated with an entity behavior enacted by the first user. In certain embodiments, the action may be indirectly associated with an entity behavior. To continue the example, the recipient of the email may open the infected binary file, and as a result, infect their computer with malware. To further continue the example, the act of opening the infected binary file is directly associated with an entity behavior enacted by the second user. However, the infection of the email recipient's computer by the infected binary file is indirectly associated with the described entity behavior enacted by the second user.

In various embodiments, certain user authentication factors 806 may be used to authenticate the identity of a user entity. In certain embodiments, the user authentication factors 806 may be used to ensure that a particular user entity, such as user ‘A’ 902 or ‘B’ 972, is associated with their corresponding user entity profile 802, rather than a user entity profile 802 associated with another user. In certain embodiments, the user authentication factors 806 may include a user's biometrics 906 (e.g., a fingerprint or retinal scan), tokens 908 (e.g., a dongle containing cryptographic keys), user identifiers and passwords (ID/PW) 910, and personal identification numbers (PINs).

In certain embodiments, information associated with such user entity behavior may be stored in a user entity profile 802, described in greater detail herein. In certain embodiments, the user entity profile 802 may be stored in a repository of entity behavior catalog (EBC) data 890. In certain embodiments, as likewise described in greater detail herein, the user entity profile 802 may include user profile attributes 804, user behavior factors 810, user mindset factors 822, or a combination thereof. As used herein, a user profile attribute 804 broadly refers to data or metadata that can be used, individually or in combination with other user profile attributes 804, user behavior factors 810, or user mindset factors 822, to ascertain the identity of a user entity. In various embodiments, certain user profile attributes 804 may be uniquely associated with a particular user entity.

As likewise used herein, a user behavior factor 810 broadly refers to information associated with a user's behavior, whether the behavior occurs within a physical realm or cyberspace. In certain embodiments, the user behavior factors 810 may include the user's access rights 812, the user's interactions 814, and the date/time/frequency 816 of those interactions 814. In certain embodiments, the user behavior factors 810 may likewise include the user's location 818 when the interactions 814 are enacted, and the user gestures 820 used to enact the interactions 814.

In various embodiments, certain date/time/frequency 816 user behavior factors 810 may be implemented as ontological or societal time, or a combination thereof. As used herein, ontological time broadly refers to how one instant in time relates to another in a chronological sense. As an example, a first user behavior enacted at 12:00 noon on May 17, 2017 may occur prior to a second user behavior enacted at 6:39 PM on May 18, 2018. Skilled practitioners of the art will recognize one value of ontological time is to determine the order in which various user behaviors have been enacted.

As likewise used herein, societal time broadly refers to the correlation of certain user profile attributes 804, user behavior factors 810, user mindset factors 822, or a combination thereof, to one or more instants in time. As an example, user ‘A’ 902 may access a particular system 956 to download a customer list at 3:47 PM on Nov. 3, 2017. Analysis of their user behavior profile indicates that it is not unusual for user ‘A’ 902 to download the customer list on a weekly basis. However, examination of their user behavior profile also indicates that user ‘A’ 902 forwarded the downloaded customer list in an email message to user ‘B’ 972 at 3:49 PM that same day. Furthermore, there is no record in their user behavior profile that user ‘A’ 902 has ever communicated with user ‘B’ 972 in the past. Moreover, it may be determined that user ‘B’ 872 is employed by a competitor. Accordingly, the correlation of user ‘A’ 902 downloading the customer list at one point in time, and then forwarding the customer list to user ‘B’ 972 at a second point in time shortly thereafter, is an example of societal time.

In a variation of the prior example, user ‘A’ 902 may download the customer list at 3:47 PM on Nov. 3, 2017. However, instead of immediately forwarding the customer list to user ‘B’ 972, user ‘A’ 902 leaves for a two week vacation. Upon their return, they forward the previously-downloaded customer list to user ‘B’ 972 at 9:14 AM on Nov. 20, 2017. From an ontological time perspective, it has been two weeks since user ‘A’ 902 accessed the system 956 to download the customer list. However, from a societal time perspective, they have still forwarded the customer list to user ‘B’ 972, despite two weeks having elapsed since the customer list was originally downloaded.

Accordingly, the correlation of user ‘A’ 902 downloading the customer list at one point in time, and then forwarding the customer list to user ‘B’ 972 at a much later point in time, is another example of societal time. More particularly, it may be inferred that the intent of user ‘A’ 902 did not change during the two weeks they were on vacation. Furthermore, user ‘A’ 902 may have attempted to mask an intended malicious act by letting some period of time elapse between the time they originally downloaded the customer list and when they eventually forwarded it to user ‘B’ 972. From the foregoing, those of skill in the art will recognize that the use of societal time may be advantageous in determining whether a particular entity behavior is of analytic utility. As used herein, mindset factors 822 broadly refer to information used to infer the mental state of a user at a particular point in time, during the occurrence of an event, an enactment of a user behavior, or combination thereof.

In certain embodiments, the security analytics system 118 may be implemented to process certain entity attribute information, described in greater detail herein, associated with providing resolution of the identity of an entity at a particular point in time. In various embodiments, the security analytics system 118 may be implemented to use certain entity identifier information, likewise described in greater detail herein, to ascertain the identity of an associated entity at a particular point in time. In various embodiments, the entity identifier information may include certain temporal information, described in greater detail herein. In certain embodiments, the temporal information may be associated with an event associated with a particular point in time.

In certain embodiments, the security analytics system 118 may be implemented to use information associated with certain entity behavior elements to resolve the identity of an entity at a particular point in time. An entity behavior element, as used herein, broadly refers to a discrete element of an entity's behavior during the performance of a particular operation in a physical realm, cyberspace, or a combination thereof. In certain embodiments, such entity behavior elements may be associated with a user/device 930, a user/network 942, a user/resource 948, a user/user 970 interaction, or a combination thereof

As an example, user ‘A’ 902 may use an endpoint device 304 to browse a particular web page on a news site on an external system 976. In this example, the individual actions performed by user ‘A’ 902 to access the web page are entity behavior elements that constitute an entity behavior, described in greater detail herein. As another example, user ‘A’ 902 may use an endpoint device 304 to download a data file from a particular system 956. In this example, the individual actions performed by user ‘A’ 902 to download the data file, including the use of one or more user authentication factors 806 for user authentication, are entity behavior elements that constitute an entity behavior. In certain embodiments, the user/device 930 interactions may include an interaction between a user, such as user ‘A’ 902 or ‘B’ 972, and an endpoint device 304.

In certain embodiments, the user/device 930 interaction may include interaction with an endpoint device 304 that is not connected to a network at the time the interaction occurs. As an example, user ‘A’ 902 or ‘B’ 972 may interact with an endpoint device 304 that is offline, using applications 932, accessing data 934, or a combination thereof, it may contain. Those user/device 930 interactions, or their result, may be stored on the endpoint device 304 and then be accessed or retrieved at a later time once the endpoint device 304 is connected to the internal 944 or external 946 networks. In certain embodiments, an endpoint agent 306 may be implemented to store the user/device 930 interactions when the endpoint device 304 is offline.

In certain embodiments, an endpoint device 304 may be implemented with a device camera 928. In certain embodiments, the device camera 928 may be integrated into the endpoint device 304. In certain embodiments, the device camera 928 may be implemented as a separate device configured to interoperate with the endpoint device 304. As an example, a webcam familiar to those of skill in the art may be implemented receive and communicate various image and audio signals to an endpoint device 304 via a Universal Serial Bus (USB) interface.

In certain embodiments, the device camera 928 may be implemented to capture and provide user/device 930 interaction information to an endpoint agent 306. In various embodiments, the device camera 928 may be implemented to provide surveillance information related to certain user/device 930 or user/user 970 interactions. In certain embodiments, the surveillance information may be used by the security analytics system 118 to detect entity behavior associated with a user entity, such as user ‘A’ 902 or user ‘B’ 972 that may be of analytic utility.

In certain embodiments, the endpoint device 304 may be used to communicate data through the use of an internal network 944, an external network 946, or a combination thereof In certain embodiments, the internal 944 and the external 946 networks may include a public network, such as the Internet, a physical private network, a virtual private network (VPN), or any combination thereof. In certain embodiments, the internal 944 and external 946 networks may likewise include a wireless network, including a personal area network (PAN), based on technologies such as Bluetooth. In various embodiments, the wireless network may include a wireless local area network (WLAN) based on variations of the IEEE 802.11 specification, commonly referred to as Wi-Fi. In certain embodiments, the wireless network may include a wireless wide area network (WWAN) based on an industry-standard, including various 3G, 4G, and 5G technologies.

In certain embodiments, the user/user 970 interactions may include interactions between two or more user entities, such as user ‘A’ 902 and ‘B’ 972. In certain embodiments, the user/user interactions 970 may be physical, such as a face-to-face meeting, via a user/device 930 interaction, a user/network 942 interaction, a user/resource 948 interaction, or some combination thereof. In certain embodiments, the user/user 970 interaction may include a face-to-face verbal exchange. In certain embodiments, the user/user 970 interaction may include a written exchange, such as text written on a sheet of paper. In certain embodiments, the user/user 970 interaction may include a face-to-face exchange of gestures, such as a sign language exchange.

In certain embodiments, temporal event information associated with various user/device 930, user/network 942, user/resource 948, or user/user 970 interactions may be collected and used to provide real-time resolution of the identity of an entity at a particular point in time. Those of skill in the art will recognize that many such examples of user/device 930, user/network 942, user/resource 948, and user/user 970 interactions are possible. Accordingly, the foregoing is not intended to limit the spirit, scope or intent of the invention.

In various embodiments, the security analytics system 118 may be implemented to process certain contextual information in the performance of certain security analytic operations. As used herein, contextual information broadly refers to any information, directly or indirectly, individually or in combination, related to a particular entity behavior. In certain embodiments, entity behavior may include a user entity's physical behavior, cyber behavior, or a combination thereof. As likewise used herein, a user entity's physical behavior broadly refers to any user behavior occurring within a physical realm, such as speaking, gesturing, facial patterns or expressions, walking, and so forth. More particularly, such physical behavior may include any action enacted by an entity user that can be objectively observed, or indirectly inferred, within a physical realm. In certain embodiments, the objective observation, or indirect inference, of the physical behavior may be performed electronically.

As an example, a user may attempt to use an electronic access card to enter a secured building at a certain time. In this example, the use of the access card to enter the building is the action and the reading of the access card makes the user's physical behavior electronically-observable. As another example, a first user may physically transfer a document to a second user, which is captured by a video surveillance system. In this example, the physical transferal of the document from the first user to the second user is the action. Likewise, the video record of the transferal makes the first and second user's physical behavior electronically-observable. As used herein, electronically-observable user behavior broadly refers to any behavior exhibited or enacted by a user entity that can be observed through the use of an electronic device (e.g., an electronic sensor), a computing device or system (e.g., an endpoint device 304 or edge device 202, a physical security device 954, a system 956, a shared device 958, etc.), computer instructions (e.g., a software application), or a combination thereof.

Cyber behavior, as used herein, broadly refers to any behavior occurring in cyberspace, whether enacted by an individual user, a group of users, or a system acting at the behest of an individual user, a group of users, or other entity. More particularly, cyber behavior may include physical, social, or mental actions that can be objectively observed, or indirectly inferred, within cyberspace. As an example, a user may use an endpoint device 304 to access and browse a particular website on the Internet. In this example, the individual actions performed by the user to access and browse the website constitute a cyber behavior. As another example, a user may use an endpoint device 304 to download a data file from a particular system 956 at a particular point in time. In this example, the individual actions performed by the user to download the data file, and associated temporal information, such as a time-stamp associated with the download, constitute a cyber behavior. In these examples, the actions are enacted within cyberspace, in combination with associated temporal information, which makes them electronically-observable.

In certain embodiments, the contextual information may include location data 936. In certain embodiments, the endpoint device 304 may be configured to receive such location data 936, which is used as a data source for determining the user's location 818. In certain embodiments, the location data 936 may include Global Positioning System (GPS) data provided by a GPS satellite 938. In certain embodiments, the location data 936 may include location data 936 provided by a wireless network, such as from a cellular network tower 940. In certain embodiments (not shown), the location data 936 may include various Internet Protocol (IP) or other network address information assigned to the endpoint device 304 or edge device 202. In certain embodiments (also not shown), the location data 936 may include recognizable structures or physical addresses within a digital image or video recording.

In certain embodiments, the endpoint devices 304 may include an input device (not shown), such as a keypad, magnetic card reader, token interface, biometric sensor, and so forth. In certain embodiments, such endpoint devices 304 may be directly or indirectly connected to a particular facility 952, physical security device 954, system 956, or shared device 958. As an example, the endpoint device 304 may be directly connected to an ingress/egress system, such as an electronic lock on a door or an access gate of a parking garage. As another example, the endpoint device 304 may be indirectly connected to a physical security device 954 through a dedicated security network.

In certain embodiments, the security analytics system 118 may be implemented to perform various risk-adaptive protection operations. Risk-adaptive, as used herein, broadly refers to adaptively responding to risks associated with an electronically-observable entity behavior. In various embodiments, the security analytics system 118 may be implemented to perform certain risk-adaptive protection operations by monitoring certain entity behaviors, assess the corresponding risk they may represent, individually or in combination, and respond with an associated response. In certain embodiments, such responses may be based upon contextual information, described in greater detail herein, associated with a given entity behavior.

In certain embodiments, various information associated with a user entity profile 802, likewise described in greater detail herein, may be used to perform the risk-adaptive protection operations. In certain embodiments, the user entity profile 802 may include user profile attributes 804, user behavior factors 810, user mindset factors 822, or a combination thereof. In these embodiments, the information associated with a user entity profile 802 used to perform the risk-adaptive protection operations is a matter of design choice.

In certain embodiments, the security analytics system 118 may be implemented as a stand-alone system. In certain embodiments, the security analytics system 118 may be implemented as a distributed system. In certain embodiments, the security analytics system 118 may be implemented as a virtual system, such as an instantiation of one or more virtual machines (VMs). In certain embodiments, the security analytics system 118 may be implemented as a security analytics service 964. In certain embodiments, the security analytics service 964 may be implemented in a cloud environment familiar to those of skill in the art. In various embodiments, the security analytics system 118 may use data stored in a repository of security analytics data in the performance of certain security analytics operations, described in greater detail herein. Those of skill in the art will recognize that many such embodiments are possible. Accordingly, the foregoing is not intended to limit the spirit, scope or intent of the invention.

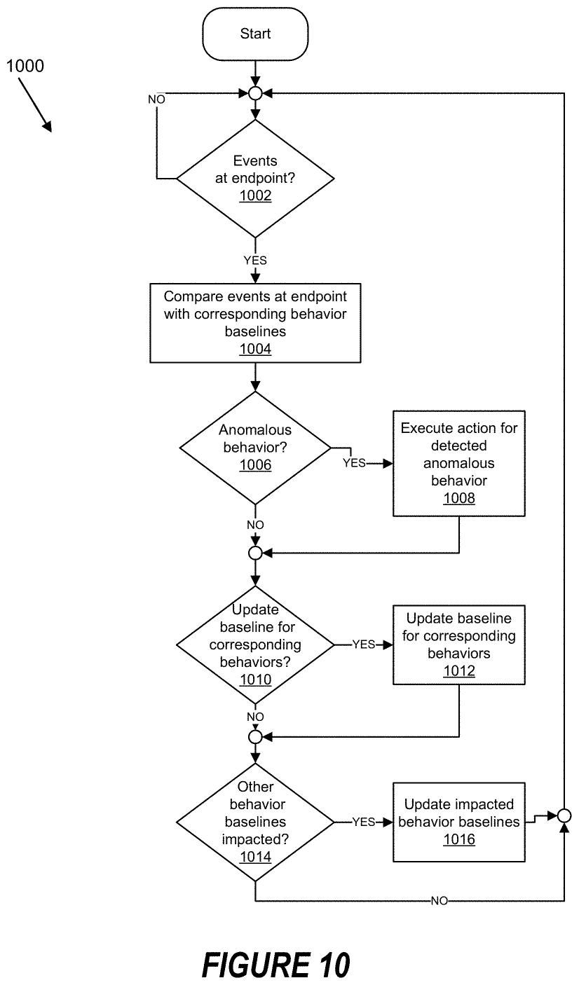

FIG. 10 is a flowchart 1000 showing exemplary operations that may be executed while using instantiated user behavior baselines in certain embodiments of the disclosed system. In this example, a determination is made at operation 1002 as to whether one or more events have occurred at the endpoint device. If not, operation 1002 is continued until such time is one or more events occur at the endpoint device.

If one or more events have occurred at the endpoint device, the events are compared with corresponding behavior baselines at operation 1004. Certain embodiments make a determination at operation 1006 as to whether the events constitute anomalous behavior as compared to the baseline behaviors. If anomalous behavior has been detected, one or more actions associated with the detection of the anomalous behavior is executed at operation 1008.

Whether or not the behavior is anomalous as determined at operation 1006, certain embodiments make a determination at operation 1010 as to whether the baseline for the behavior expressed in the events should be updated. As an example, a user behavior baseline for a file access behavior may be updated when the events indicate that the user has accessed, created, and/or modified a file. If a determination is made at operation 1010 that the baseline for the corresponding behavior is to be updated, certain embodiments execute the update at operation 1012.

Whether or not the baseline for the user behavior is updated at operation 1010, certain embodiments make a determination at operation 1014 as to whether other behavior baselines are impacted by the events received at operation 1002. As an example, time-related user behaviors may be impacted when the user accesses a website using a web browser at a particular time of day. As a further example, time-related user behaviors may be impacted when the user sends an email at a particular time of day. If other behavior baselines are impacted based on the determination made at operation 1014, the impacted baseline behavior is updated at operation 1016. Whether or not other user behaviors have been impacted by the detected offense, certain embodiments continue to monitor events occurring at the endpoint device at operation 1002.

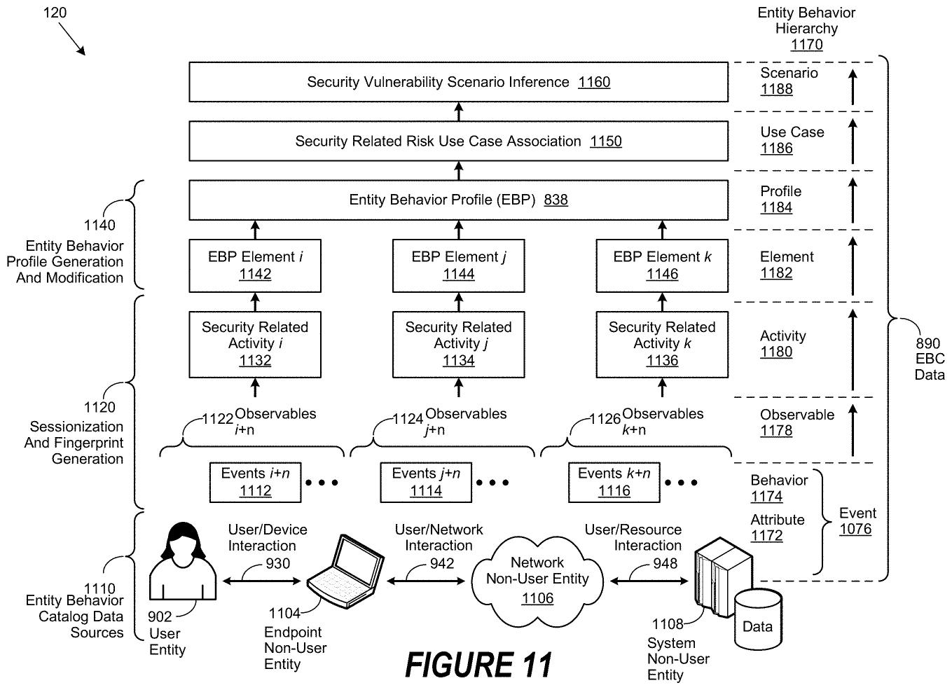

FIG. 11 is a simplified block diagram showing the mapping of an event to a security vulnerability scenario implemented in accordance with an embodiment of the disclosed system. In certain embodiments, an entity behavior catalog (EBC) system 120 may be implemented to identify a security-related activity, described in greater detail herein. In certain embodiments, the security-related activity may be based upon an observable, likewise described in greater detail herein. In certain embodiments, the observable may include event information corresponding to electronically-observable behavior enacted by an entity. In certain embodiments, the event information corresponding to electronically-observable behavior enacted by an entity may be received from an electronic data source.

In certain embodiments, as likewise described in greater detail herein, the EBC system 120 may be implemented to identify a particular event of analytic utility by analyzing an associated security-related activity. In certain embodiments, the EBC system 120 may be implemented to generate entity behavior catalog data based upon an identified event of analytic utility associated with a particular security-related activity. In various embodiments, the EBC system 120 may be implemented to associate certain entity behavior data it may generate with a predetermined abstraction level, described in greater detail herein.

In various embodiments, the EBC system 120 may be implemented to use certain EBC data 890 and an associated abstraction level to generate a hierarchical set of entity behaviors 1170, described in greater detail herein. In certain embodiments, the hierarchical set of entity behaviors 1170 generated by the EBC system 120 may represent an associated security risk, likewise described in greater detail herein. Likewise, the EBC system 120 may be implemented in certain embodiments to store the hierarchical set of entity behaviors 1170 and associated abstraction level information within a repository of EBC data 890. In certain embodiments, the repository of EBC data 890 may be implemented to provide an inventory of entity behaviors for use when performing a security operation, likewise described in greater detail herein.

Referring now to FIG. 11, the EBC system 120 may be implemented in various embodiments to receive certain event information, described in greater detail herein, corresponding to an event associated with an entity interaction. As used herein, event information broadly refers to any information directly or indirectly related to an event. As likewise used herein, an event broadly refers to the occurrence of at least one action performed by an entity. In certain embodiments, the at least one action performed by an entity may include the enactment of an entity behavior, described in greater detail herein. In certain embodiments, the entity behavior may include an entity's physical behavior, cyber behavior, or a combination thereof, as likewise described in greater detail herein.

Likewise, as used herein, an entity interaction broadly refers to an action influenced by another action enacted by an entity. As an example, a first user entity may perform an action, such as sending a text message to a second user entity, who in turn replies with a response. In this example, the second user entity's action of responding is influenced by the first user entity's action of sending the text message. In certain embodiments, an entity interaction may include the occurrence of at least one event enacted by one entity when interacting with another. In certain embodiments, an event associated with an entity interaction may include at least one entity attribute, described in greater detail herein, and at least one entity behavior, likewise described in greater detail herein.

In certain embodiments, an entity attribute and an entity behavior may be respectively abstracted to an entity attribute 1172 and an entity behavior 1174 abstraction level. In certain embodiments, an entity attribute 1172 and an entity behavior 1174 abstraction level may then be associated with an event 1176 abstraction level. In certain embodiments, the entity attribute 1172, entity behavior 1174, and event 1176 abstraction levels may in turn be associated with a corresponding entity behavior hierarchy 1170.

In various embodiments, the event information may be received from certain EBC data sources 1110, such as a user 1102 entity, an endpoint 1104 non-user entity, a network 1106 non-user entity, or a system 1108 non-user entity. In certain embodiments, one or more events may be associated with a particular entity interaction. As an example, as shown in FIG. 11, one or more events i+n 1112 may be associated with a user/device 930 interaction between a user 1102 entity and an endpoint 904 non-user entity. Likewise, one or more events j+n 1114 may be associated with a user/network 942 interaction between a user 1102 entity and a network 1106 non-user entity. As likewise shown in FIG. 11, one or more events k+n 1116 may be associated with a user/resource 948 interaction between a user 1102 entity and a system 1108 non-user entity.

In certain embodiments, details of an event, such as events i+n 1112, j+n 1114, and k+n 1116, may be included in their associated event information. In various embodiments, analytic utility detection operations may be performed on such event information to identify events of analytic utility. In various embodiments, certain event information associated with an event determined to be of analytic utility may be used to derive a corresponding observable. As used herein, an observable broadly refers to an event of analytic utility whose associated event information may include entity behavior that may be anomalous, abnormal, unexpected, malicious, or some combination thereof.

As an example, the details contained in the event information respectively corresponding to events i+n 1112, j+n 1114, and k+n 1116 may be used to derive observables i+n 1122, j+n 1124, and k+n 1126. In certain embodiments, the resulting observables i+n 1122, j+n 1124, and k+n 1126 may then be respectively associated with a corresponding observable 1178 abstraction level. In certain embodiments, the observable 1178 abstraction level may in turn be associated with a corresponding entity behavior hierarchy 1170.

In certain embodiments, the resulting observables may in turn be processed to generate an associated security-related activity. As used herein, a security-related activity broadly refers to an abstracted description of an interaction between two entities, described in greater detail herein, which may represent anomalous, abnormal, unexpected, malicious entity behavior. For example, observables i+n 1122, j+n 1124, and k+n 1126 may in turn be processed to generate corresponding security-related activities i 1132, j 1134, and k 1136. In certain embodiments, the resulting security-related activities, i 1132, j 1134, and k 1136 may then be respectively associated with a corresponding security-related activity 1180 abstraction level. In certain embodiments, the security-related activity 1180 abstraction level may in turn be associated with a corresponding entity behavior hierarchy 1170.

In various embodiments, sessionization and fingerprint generation operations 1120, described in greater detail herein, may be performed to associate certain events, observables, and security-related activities, or a combination thereof, with a corresponding session, likewise described in greater detail herein. As an example, events i+n 1112, j+n 1114, k+n 1116, observables i+n 1122, j+n 1124, k+n 1126, and security-related activities i 1132, j 1134, k 1136 may be associated with corresponding sessions. In certain embodiments, a security-related activity may be processed with associated contextual information, described in greater detail herein, to generate a corresponding EBP element.

For example, security-related activities i 1132, j 1134, and k 1136 may be processed with associated contextual information to generate corresponding EBP elements i 1142, j 1144, and k 1146. In various embodiments, the resulting EBP elements i 1142, j 1144, and k 1146 may then be associated with a corresponding EBP element 1182 abstraction level. In certain embodiments, the EBP element 1182 abstraction level may in turn be associated with a corresponding entity behavior hierarchy 1170.

In certain embodiments, EBP generation and modification 1140 operations may be performed to associate one or more EBP elements with a particular EBP 1138. As an example, EBP elements i 1142, j 1144, and k 946 may be associated with a particular EBP 1138, which may likewise be respectively associated with the various entities involved in the user/device 930, user/network 942, or user/resource 948 interactions. In these embodiments, the method by which the resulting EBP elements i 1142, j 1144, and k 1146 are associated with a particular EBP 838 is a matter of design choice. In certain embodiments, the EBP 838 may likewise be associated with an EBP 1184 abstraction level. In certain embodiments, the EBP 1184 abstraction level may in turn be associated with a corresponding entity behavior hierarchy 1170.

In various embodiments, the resulting EBP 838 may be used in the performance of security risk use case association 1150 operations to identify one or more security risk use cases that match certain entity behavior information stored in the EBP 838. As used herein, a security risk use case broadly refers to a set of security-related activities that create a security risk narrative that can be used to adaptively draw inferences, described in greater detail herein, from entity behavior enacted by a particular entity. In certain of these embodiments, the entity behavior information may be stored within the EBP 838 in the form of an EBP element, a security-related activity, an observable, or an event, or a combination thereof. In certain embodiments, the security risk use case association operations may be performed by the security risk use case management module 128 of the EBC system 120 described in the text associated with FIG. 8a. In certain embodiments, identified security risk use cases may then be associated with a security risk use case 1186 abstraction level. In certain embodiments, the security risk use case 1186 abstraction level may in turn be associated with a corresponding entity behavior hierarchy 1170.

In certain embodiments, the results of the security risk use case association 1150 operations may in turn be used to perform security vulnerability scenario inference 1160 operations to associate one or more security risk use cases with one or more security vulnerability scenarios. As used herein, a security vulnerability scenario broadly refers to a grouping of one or more security risk use cases that represent a particular class of security vulnerability. In certain embodiments, the security vulnerability scenario association operations may be performed by the security vulnerability scenario management module 126 of the EBC system 120 described in the text associated with FIG. 8a. In certain embodiments, the associated security vulnerability scenarios may then be associated with a security vulnerability scenario 1188 abstraction level. In certain embodiments, the security vulnerability scenario 1188 abstraction level may in turn be associated with a corresponding entity behavior hierarchy 1170.

In various embodiments, certain event information associated with events i+n 1112, j+n 1114, and k+n 1116 and certain observable information associated with observables i+n 1122, j+n 1124, and k+n 1126 may be stored in a repository of EBC data 890. In various embodiments, certain security-related activity information associated with security-related activities i 1132, j 1134, and k 1136 and EBP elements i 1142, j 1144, and k 1146 may likewise be stored in the repository of EBC data 890. Likewise, in various embodiments, certain security risk use case association and security vulnerability scenario association information respectively associated with the performance of security risk use case association 1150 and security vulnerability scenario inference 1160 operations may be stored in the repository of EBC data 890.

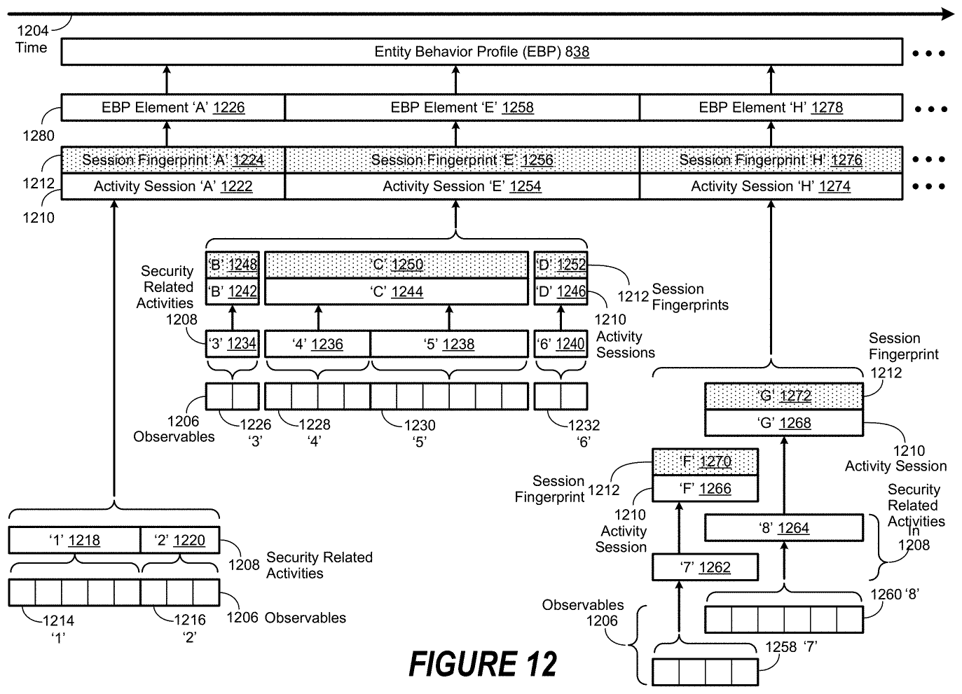

FIG. 12 is a simplified block diagram of the generation of a session and a corresponding session-based fingerprint implemented in accordance with an embodiment of the disclosed system. In certain embodiments, an observable 1206 may be derived from an associated event. In certain embodiments, one or more observables 1206 may be processed to generate a corresponding security-related activity 1208. In certain embodiments, one or more security-related activities 1208 may then be respectively processed to generate a corresponding activity session 1210. In turn, the session 1210 may be processed in certain embodiments to generate a corresponding session fingerprint 1212. In certain embodiments, the resulting activity session 1210 and its corresponding session fingerprint 1212, individually or in combination, may then be associated with a particular entity behavior profile (EBP) element 1280. In certain embodiments, the EBP element 1280 may in turn be associated with an EBP 838.

In certain embodiments, intervals in time 1204 respectively associated with various security-related activities 1208 may be contiguous. For example, as shown in FIG. 12, the intervals in time 1204 associated with observables 1206 ‘1’ 1214 and ‘2’ 1216 may be contiguous. Accordingly, the intervals in time 1204 associated with the security-related activities 1208 ‘1’ 1218 and ‘2’ 1220 respectively generated from observables 1206 ‘1’ 1214 and ‘2’ 1216 would likewise be contiguous.

As likewise shown in FIG. 12, the resulting security-related activities 1208 ‘1’ 1218 and ‘2’ 1220 may be processed to generate an associated activity session ‘A’ 1222, which then may be processed to generate a corresponding session fingerprint ‘A’ 1224. In certain embodiments, activity session ‘A’ 1222 and its corresponding session fingerprint ‘A’ 1224 may be used to generate a new entity behavior profile (EBP) element 1280 ‘A’ 1226. In certain embodiments, EBP element 1280 ‘A’ 1226 generated from activity session 1210 ‘A’ 1222 and its corresponding session fingerprint 1212 ‘A’ 1224 may be associated with an existing EBP 838.

As an example, a user may enact various observables 1206 ‘1’ 1214 to update sales forecast files, followed by the enactment of various observables 1206 ‘2’ 1016 to attach the updated sales forecast files to an email, which is then sent to various co-workers. In this example, the enactment of observables 1206 ‘1’ 1214 and ‘2’ 1216 result in the generation of security-related activities 1208 ‘1’ 1218 and ‘2’ 1220, which in turn are used to generate activity session 1210 ‘A’ 1222. In turn, the resulting activity session 1210 ‘A’ 1222 is then used to generate its corresponding session-based fingerprint 1212 ‘A’ 1224. To continue the example, activity session 1210 ‘A’ 1222 is associated with security-related activities 1208 ‘1’ 1218 and ‘2’ 1220, whose associated intervals in time 1204 are contiguous, as they are oriented to the updating and distribution of sales forecast files via email.

Various aspects of the disclosed system reflect an appreciation that a user may enact certain entity behaviors on a recurring basis. To continue the preceding example, a user may typically update sales forecast files and distribute them to various co-workers every morning between 8:00 AM and 10:00 AM. Accordingly, the activity session 1210 associated with such a recurring activity may result in a substantively similar session fingerprint 1212 week-by-week. However, a session fingerprint 1212 for the same session 1210 may be substantively different should the user happen to send an email with an attached sales forecast file to a recipient outside of their organization. Consequently, a session fingerprint 1212 that is inconsistent with session fingerprints 1212 associated with past activity sessions 1210 may indicate anomalous, abnormal, unexpected or malicious behavior.

In certain embodiments, two or more activity sessions 1210 may be noncontiguous, but associated. In certain embodiments, an activity session 1210 may be associated with two or more sessions 1210. In certain embodiments, an activity session 1210 may be a subset of another activity session 1210. As an example, as shown in FIG. 12, the intervals in time 1204 respectively associated with observables 1206 ‘3’ 1214 and ‘6’ 1232 may be contiguous. Likewise, the intervals in time 1204 associated with observables 1206 ‘4’ 1236 and ‘5’ 1238 may be contiguous.

Accordingly, the intervals in time 1204 associated with the security-related activities 1208 ‘4’ 1236 and ‘5’ 1238 respectively generated from observables 1206 ‘4’ 1228 and ‘5’ 1230 would likewise be contiguous. However, the intervals in time 1204 associated with security-related activities 1208 ‘4’ 1236 and ‘5’ 1238 would not be contiguous with the intervals in time respectively associated with security-related activities 1208 ‘3’ 1234 and ‘6’ 1240.

As likewise shown in FIG. 12, the resulting security-related activities 1208 ‘3’ 1234 and ‘6’ 1240 may be respectively processed to generate corresponding sessions ‘B’ 1242 and ‘D’ 1246, while security-related activities 1208 ‘4’ 1236 and ‘5’ 1238 may be processed to generate activity session 1210 ‘C’ 1244. In turn, activity sessions 1210 ‘B’ 1242, ‘C’ 1244, and ‘D’ 1246 are then respectively processed to generate corresponding session-based fingerprints 1212 ‘B’ 1248, ‘C’ 1250 and ‘D’ 1252.

Accordingly, the intervals of time 1204 respectively associated with activity sessions 1210 ‘B’ 1242, ‘C’ 1244, and ‘D’ 1246, and their corresponding session fingerprints 1212 ‘B’ 1248, ‘C’ 1250 and ‘D’ 1252, are not contiguous. Furthermore, in this example activity sessions 1210 ‘B’ 1242, ‘C’ 1244, and ‘D’ 1246, and their corresponding session fingerprints 1212 ‘B’ 1248, ‘C’ 1250 and ‘D’ 1252, are not associated with the EBP 838. Instead, as shown in FIG. 12, activity sessions 1210 ‘B’ 1242, ‘C’ 1244, and ‘D’ 1246 are processed to generate activity session 1210 ‘E’ 1254 and session fingerprints 1212 ‘B’ 1248, ‘C’ 1250 and ‘D’ 1252 are processed to generate session fingerprint 1212 ‘E’ 1256. In certain embodiments, activity session ‘E’ 1254 and its corresponding session fingerprint ‘E’ 1256 may be used to generate a new EBP element 1280 ‘E’ 1258. In certain embodiments, EBP element 1280 ‘E’ 1258 generated from activity session 1210 ‘E’ 1254 and its corresponding session fingerprint 1212 ‘E’ 1256 may be associated with an existing EBP 838.

Accordingly, session 1210 ‘E’ 1054 is associated with activity sessions 1210 ‘B’ 1242, ‘C’ 1244, and ‘D’ 1246. Likewise, sessions 1210 ‘B’ 1242, ‘C’ 1244, and ‘D’ 1246 are subsets of session 1210 ‘E’ 1254. Consequently, while the intervals of time respectively associated with activity sessions 1210 ‘B’ 1242, ‘C’ 1244, and ‘D’ 1246, and their corresponding session fingerprints 1212 ‘B’ 1248, ‘C’ 1250 and ‘D’ 1252 may not be contiguous, they are associated as they are respectively used to generate session 1210 ‘E’ 1254 and its corresponding session fingerprint 1212 ‘E’ 1056.

To provide an example, a user plans to attend a meeting scheduled for 10:00 AM at a secure facility owned by their organization to review a project plan with associates. However, the user wishes to arrive early to prepare for the meeting. Accordingly, they arrive at 9:00 AM and use their security badge to authenticate themselves and enter the facility. In this example, the enactment of observables 1206 ‘3’ 1226 may correspond to authenticating themselves with their security badge and gaining access to the facility. As before, observables 1206 ‘3’ 1226 may be used to generate a corresponding security-related activity 1208 ‘3’ 1234. In turn, the security-related activity 1208 ‘3’ 1234 may then be used to generate session 1210 ‘B’ 1242, which is likewise used in turn to generate a corresponding session fingerprint 1212 ‘B’ 1248.

The user then proceeds to a conference room reserved for the meeting scheduled for 10:00 AM and uses their time alone to prepare for the upcoming meeting. Then, at 10:00 AM, the scheduled meeting begins, followed by the user downloading the current version of the project plan, which is then discussed by the user and their associate for a half hour. At the end of the discussion, the user remains in the conference room and spends the next half hour making revisions to the project plan, after which it is uploaded to a datastore for access by others.

In this example, observables 1206 ‘4’ 1228 may be associated with the user downloading and reviewing the project plan, and observables 1206 ‘5’ 1230 may be associated with the user making revisions to the project plan and then uploading the revised project plan to a datastore. Accordingly, behavior elements ‘3’ 1226 ‘4’ 1228 and ‘5’ 1230 may be respectively used to generate security-related activities 1208 ‘4’ 1236 and ‘5’ 1238. In turn, the security-related activities 1208 ‘4’ 1236 and ‘5’ 1238 may then be used to generate session 1210 ‘C’ 1244, which may likewise be used in turn to generate its corresponding session-based fingerprint 1212 ‘C’ 1250.

To continue the example, the user may spend the next half hour discussing the revisions to the project plan with a co-worker. Thereafter, the user uses their security badge to exit the facility. In continuance of this example, observables 1206 ‘6’ 1232 may be associated with the user using their security badge to leave the secure facility. Accordingly, observables 1206 ‘6’ 1232 may be used to generate a corresponding security-related activity 1208 ‘6’ 1240, which in turn may be used to generate a corresponding session 1210 ‘D’ 1246, which likewise may be used in turn to generate a corresponding session fingerprint 1212 ‘D’ 1252.

In this example, the intervals of time 1204 respectively associated with activity sessions 1210 ‘B’ 1242, ‘C’ 1244, and ‘D’ 1246, and their corresponding session fingerprints 1212 ‘B’ 1248, ‘C’ 1250, and ‘D’ 1252, are not contiguous. However, they may be considered to be associated as their corresponding observables 1206 ‘3’ 1226, ‘4’ 1228, ‘5’ 1230, and ‘6’ 1232, all have the common attribute of having been enacted within the secure facility. Furthermore, security-related activities 1208 ‘4’ 1236 and ‘5’ 1238 may be considered to be associated as their corresponding observables 1206 have the common attribute of being associated with the project plan.

Accordingly, while the intervals of time 1204 respectively associated with activity sessions 1210 ‘B’ 1242, ‘C’ 1244, and ‘D’ 1246, and their corresponding session-based fingerprints 1212 ‘B’ 1248, ‘C’ 1250, and ‘D’ 1252, may not be contiguous, they may be considered to be associated. Consequently, sessions 1210 ‘B’ 1242, ‘C’ 1244, and ‘D’ 1246 may be considered to be a subset of session 1210 ‘E’ 1254 and session-based fingerprints 1212 ‘B’ 1248, ‘C’ 1250, and ‘D’ 1252 may be considered to be a subset of session-based fingerprint 1212 ‘E’ 1256.

In certain embodiments, the interval of time 1204 corresponding to a first activity session 1210 may overlap an interval of time 1204 corresponding to a second activity session 1210. For example, observables 1206 ‘7’ 1258 and ‘8’ 1260 may be respectively processed to generate security-related activities 1208 ‘7’ 1262 and ‘8’ 1264. In turn, the resulting security-related activities 1208 ‘7’ 1262 and ‘8’ 1264 are respectively processed to generate corresponding activity sessions 1210 ‘F’ 1266 and ‘G’ 1268. Sessions The resulting activity sessions 1210 ‘F’ 1266 and ‘G’ 1268 are then respectively processed to generate corresponding session-based fingerprints 1212 ‘F’ 1270 and ‘G’ 1272.

However, in this example activity sessions 1210 ‘F’ 1266 and ‘G’ 1268, and their corresponding session fingerprints 1212 ‘F’ 1270 and ‘G’ 1272, are not associated with the EBP 838. Instead, as shown in FIG. 12, activity sessions 1210 ‘F’ 1266 and ‘G’ 1268 are processed to generate activity session 1210 ‘E’ 1254 and session fingerprints 1212 ‘F’ 1270 and ‘G’ 1272 are processed to generate session fingerprint 1212 ‘H’ 1276. In certain embodiments, activity session ‘H’ 1274 and its corresponding session fingerprint ‘H’ 1276 may be used to generate a new EBP element 1280 ‘H’ 1278. In certain embodiments, EBP element 1280 ‘H’ 1278 generated from activity session 1210 ‘E’ 1274 and its corresponding session fingerprint 1212 ‘E’ 1276 may be associated with an existing EBP 838.

Accordingly, the time 1204 interval associated with activity session 1210 ‘F’ 1266 and its corresponding session fingerprint 1212 ‘F’ 1270 overlaps with the time interval 1204 associated with activity session 1210 ‘G’ 1268 and its corresponding session fingerprint 1212 ‘G’ 1272. As a result, activity sessions 1210 ‘F’ 1266 and ‘G’ 1268 are subsets of activity session 1210 ‘H’ 1274. Consequently, while the intervals of time respectively associated with activity sessions 1210 ‘F’ 1266 and ‘G’ 1268, and their corresponding session fingerprints 1212 ‘F’ 1270 and ‘G’ 1272 may overlap, they are associated as they are respectively used to generate activity session 1210 ‘H’ 1274 and its corresponding session fingerprint 1212 ‘H’ 1276.

To provide an example, a user may decide to download various images for placement in an online publication. In this example, observables 1206 ‘7’ 1258 may be associated with the user iteratively searching for, and downloading, the images they wish to use in the online publication. However, the user may not begin placing the images into the online publication until they have selected and downloaded the first few images they wish to use.

To continue the example, observables 1206 ‘8’ may be associated with the user placing the downloaded images in the online publication. Furthermore, the placement of the downloaded images into the online publication may begin a point in time 1204 subsequent to when the user began to download the images. Moreover, the downloading of the images may end at a point in time 1204 sooner than when the user completes the placement of the images in the online publication.

In continuance of the example, observables 1206 ‘7’ 1258 and ‘8’ 1260 may be respectively processed to generate security-related activities 1208 ‘7’ 1262 and ‘8’ 1264, whose associated intervals of time 1204 overlap one another. Accordingly, the intervals in time 1204 associated with activity sessions 1210 ‘F’ 1266 and ‘G’ 1268 will likewise overlap one another as they are respectively generated from security-related activities 1208 ‘7’ 1262 and ‘8’ 1264.

Consequently, while the intervals of time 1204 respectively associated with activity sessions 1210 ‘F’ 1266 and ‘G’ 1268, and their corresponding session fingerprints 1212 ‘F’ 1270 and ‘G’ 1272, may overlap, they may be considered to be associated as they both relate to the use of images for the online publication. Accordingly, activity sessions 1210 ‘F’ 1266 and ‘G’ 1268 may be considered to be a subset of activity session 1210 ‘H’ 1274 and session fingerprints 1212 ‘F’ 1270 and ‘G’ 1272 may be considered to be a subset of session fingerprint 1212 ‘H’ 1276.

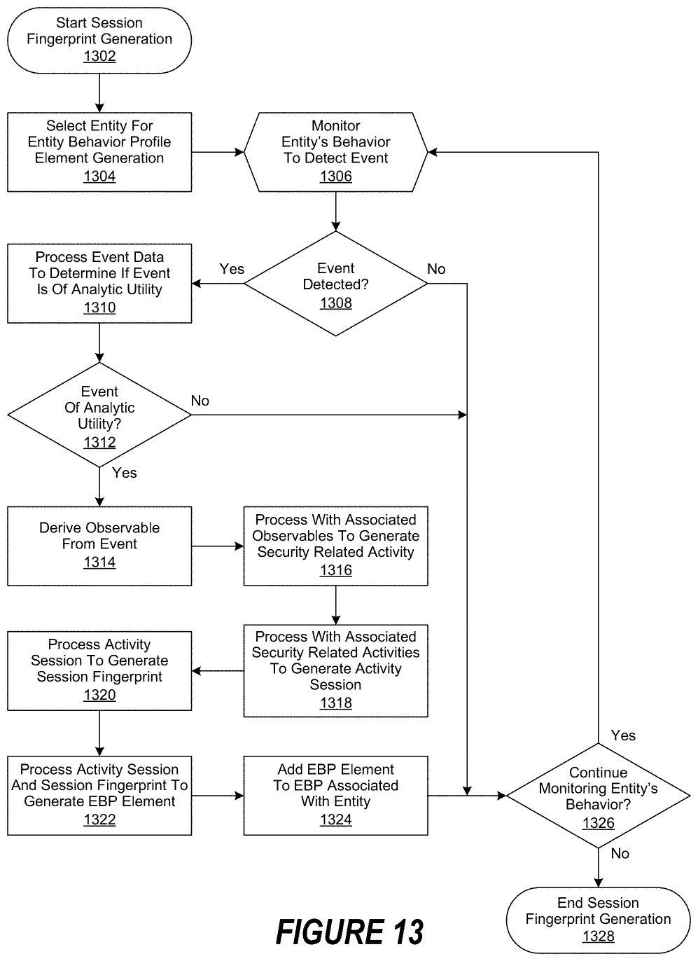

FIG. 13 is a generalized flowchart of session fingerprint generation operations performed in accordance with an embodiment of the disclosed system. In this embodiment, activity session fingerprint generation operations are begun in step 1302, followed by the selection of an entity in step 1304 for associated entity behavior profile (EBP) element generation. As used herein, an EBP element broadly refers to any data element stored in an EBP. In various embodiments, an EBP element may be used to describe a particular aspect of an EBP, such as certain entity behaviors enacted by an entity associated with the EBP. Ongoing monitoring operations are then performed in step 1306 to monitor the selected entity's behavior to detect the occurrence of an event.

A determination is then made in step 1308 whether an event has been detected. If not, then a determination is made in step 1326 whether to continue monitoring the entity's behavior to detect an event. If so, then the process is continued, proceeding with step 1306. Otherwise, session fingerprint generation operations are ended in step 1328. However, if it was determined in step 1308 that an event was detected, then event data associated with the detected event is processed to determine whether the event is of analytic utility.

A determination is then made in step 1312 to determine whether the event is of analytic utility. If not, then the process is continued, proceeding with 1326. Otherwise, an observable, described in greater detail herein, is derived from the event in step 1314. The resulting observable is then processed with associated observables in step 1316, as likewise described in greater detail herein, to generate a security-related activity. As likewise described in greater detail herein, the resulting security-related activity is then processed in step 1318 with associated security-related activities to generate an activity session.

In turn, the resulting activity session is then processed in step 1320 to generate a corresponding session fingerprint. The resulting session fingerprint is then processed with its corresponding activity session in step 1322 to generate an associated EBP element. The resulting EBP element is then added to an EPB associated with the entity in step 1324 and the process is then continued, proceeding with step 1326.

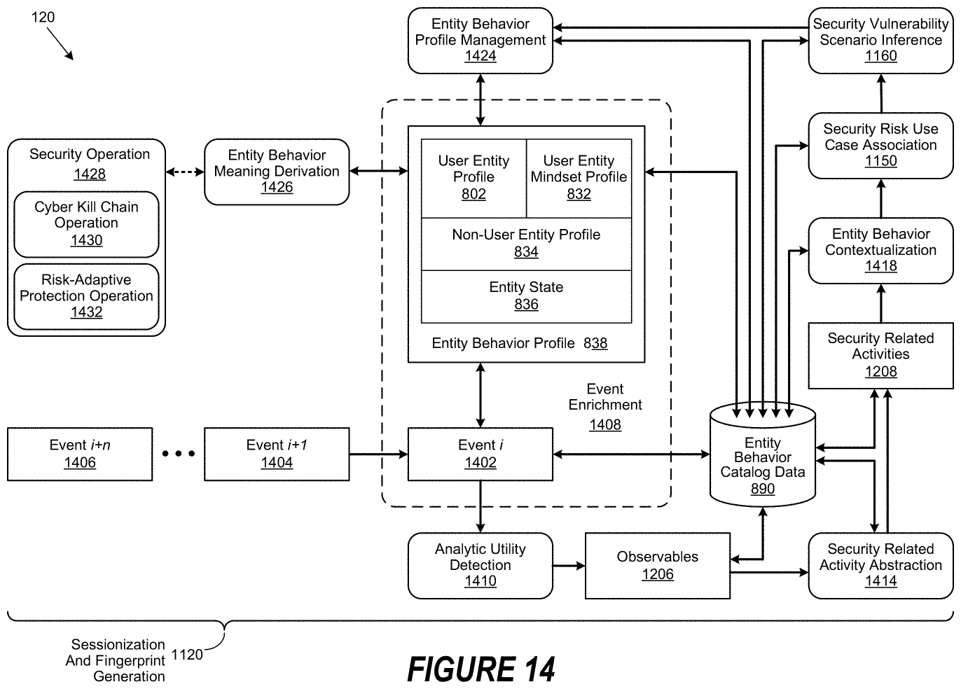

With reference to FIG. 14, in certain embodiments of the disclosed system, the EBC system 120 operations are begun with the receipt of information associated with an initial event i 1402. In certain embodiments, information associated with an initial event i 1402 may include user entity profile 802 attributes, user behavior factors, user entity mindset factors, entity state information, contextual information, all described in greater detail herein, or a combination thereof. In various embodiments, certain user entity profile 802 data, user entity mindset profile 832 data, non-user entity profile 834 data, entity state 836 data, contextual information, and temporal information stored in a repository of EBC data 890 may be retrieved and then used to perform event enrichment 1408 operations to enrich the information associated with event i 1402. In certain embodiments, event enrichment 1408 operations may be performed by the event enrichment module 880 of the EBC system 120 described in the text associated with FIG. 8a.

Analytic utility detection 1412 operations are then performed on the resulting enriched event i 1402 to determine whether it is of analytic utility. If so, then it is derived as an observable 1306, described in greater detail herein. In certain embodiments, event i+1 1404 through event i+n 1406, may in turn be received by the EBC system 120 and be enriched 1308. Analytic utility detection 1412 operations are then performed on the resulting enriched event i+l 1404 through event i+n 1406 to determine whether they are of analytic utility. Observables 1206 are then derived from those that are. In certain embodiments, the analytic utility detection 1412 operations may be performed by the analytic utility detection 882 of the EBC system 120 described in the text associated with FIG. 8a.

In certain embodiments, security-related activity abstraction 1414 operations may be performed on the resulting observables 1206 corresponding to events i 1402, i+l 1404, i+n 1406 to generate an associated security-related activity 1208, described in greater detail herein. In various embodiments, a security-related activity 1208 may be expressed in a Subject→Action→Object format and associated with observables 1206 resulting from event information provided by various received from certain EBC data sources, likewise described in greater detail herein. In certain embodiments, a security-related activity abstraction 1414 operation may be performed to abstract away EBC data source-specific knowledge and details when expressing an entity behavior. For example, rather than providing the details associated with a “Windows: 4624” non-user entity event, its details may be abstracted to “User Login To Device” security-related activity 1208.

In various embodiments, sessionization and fingerprint 1420 operations, described in greater detail herein, may be performed on event information corresponding to events i 1402, i+l 1404, i+n 1406, their corresponding observables 1206, and their associated security-related activities 1208, or a combination thereof, to generate session information. In various embodiments, the resulting session information may be used to associate certain events i 1402, i+l 1404, i+n 1406, or their corresponding observables 1206, or their corresponding security-related activities 1208, or a combination thereof, with a particular session.

In certain embodiments, as likewise described in greater detail herein, one or more security-related activities 1208 may in turn be associated with a corresponding EBP element. In various embodiments, the previously-generated session information may be used to associate the one or more security-related activities 1208 with a particular EBP element. In certain embodiments, the one or more security-related activities 1208 may be associated with its corresponding EBP element through the performance of an EBP management operation 1424. Likewise, in certain embodiments, one or more EBP elements may in turn be associated with the EBP 838 through the performance of an EBP management operation 1424. In certain embodiments, the EBP management 1324 operations may be performed by the EBP management module 124 of the EBC system 120 described in the text associated with FIG. 8a.

In various embodiments, certain contextualization information stored in the repository of EBC data 890 may be retrieved and then used to perform entity behavior contextualization 1418 operations to provide entity behavior context, based upon the entity's user entity profile 802, or non-user entity profile 834, and its associated entity state 836. In certain embodiments, the entity behavior contextualization 1418 operations may be performed by the entity behavior contextualization module 884 of the EBC system 120, described in the text associated with FIG. 8a. In various embodiments, security risk use case association 1150 operations may be performed to associate an EBP 838 with a particular security risk use case. In certain embodiments, the results of the previously-performed entity behavior contextualization 1418 operations may be used to perform the security risk use case association 1150 operations. In certain embodiments, the security risk use case association 1150 operations may be performed by the security risk use case management module 128 of the EBC system 120 described in the text associated with FIG. 8a.

In various embodiments, security vulnerability scenario inference 1160 operations may be performed to associate a security risk use case with a particular security vulnerability scenario, described in greater detail herein. In various embodiments, certain observables 1206 derived from events of analytical utility may be used to perform the security vulnerability scenario inference 1160 operations. In various embodiments, certain entity behavior contexts resulting from the performance of the entity behavior contextualization 1418 operations may be used to perform the security vulnerability scenario inference 1160 operations. In certain embodiments, the security vulnerability scenario inference 1160 operations may be performed by the security vulnerability scenario management module 126 of the EBC system 120 described in the text associated with FIG. 8a.

In certain embodiments, entity behavior meaning derivation 1426 operations may be performed on the security vulnerability behavior scenario selected as a result of the performance of the security vulnerability scenario inference 1160 operations to derive meaning from the behavior of the entity. In certain embodiments, the entity behavior meaning derivation 1426 operations may be performed by analyzing the contents of the EBP 838 in the context of the security vulnerability behavior scenario selected as a result of the performance of the security vulnerability scenario inference 1160 operations. In certain embodiments, the derivation of entity behavior meaning may include inferring the intent of an entity associated with event i 1402 and event i+l 1404 through event i+n 1406. In certain embodiments, the entity behavior meaning derivation 1426 operations may be performed by the entity behavior meaning derivation module 886 of the EBC system 120 described in the text associated with FIG. 8.

In various embodiments, the performance of the entity behavior meaning derivation operations 1426 may result in the performance of a security operation 1428, described in greater detail herein. In certain embodiments, the security operation 1428 may include a cyber kill chain 1430 operation, or a risk-adaptive protection 1432 operation, or both. In certain embodiments, the cyber kill chain 1430 operation may be performed to disrupt the execution of a cyber kill chain, described in greater detail herein. In certain embodiments, the risk-adaptive protection 1432 operation may include adaptively responding with an associated risk-adaptive response.

In various embodiments, the security operation 1428 may include certain risk mitigation operations being performed by a security administrator. As an example, the performance of the security operation 1428 may result in a notification being sent to a security administrator alerting them to the possibility of suspicious behavior. In certain embodiments, the security operation 1428 may include certain risk mitigation operations being automatically performed by a security analytics system or service. As an example, the performance of the security operation 1428 may result in a user's access to a particular system being disabled if an attempted access occurs at an unusual time or from an unknown device.

In certain embodiments, meaning derivation information associated with event i 1402 may be used to update the user entity profile 802 or non-user entity profile 834 corresponding to the entity associated with event i 1402. In certain embodiments, the process is iteratively repeated, proceeding with meaning derivation information associated with event i+l 1404 through event i+n 1406. From the foregoing, skilled practitioners of the art will recognize that a user entity profile 802, or a non-user entity profile 834, or the two in combination, as implemented in certain embodiments, not only allows the identification of events associated with a particular entity that may be of analytic utility, but also provides higher-level data that allows for the contextualization of observed events. Accordingly, by viewing individual sets of events both in context and with a view to how they may be of analytic utility, it is possible to achieve a more nuanced and higher-level comprehension of an entity's intent.

As will be appreciated by one skilled in the art, the present invention may be embodied as a method, system, or computer program product. Accordingly, embodiments of the disclosed system may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer-usable or computer-readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the disclosed system are described with reference to flowchart illustrations and/or block diagrams of methods, apparatus (systems) and computer program products according to embodiments of the disclosed system. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be evident to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation, no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

The present invention is well adapted to attain the advantages mentioned as well as others inherent therein. While the present invention has been depicted, described, and is defined by reference to particular embodiments of the disclosed system, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implemented method for instantiating user behavior baselines in a secured network, comprising:
accessing historical data stored on an endpoint device during an initialization of the endpoint device on the secured network;
instantiating user behavior baselines for the endpoint device using the accessed historical data; and
storing the instantiated user behavior baselines on a security system of the secured network for detecting instances of anomalous user behavior occurring at the endpoint device.

2. The computer-implemented method of claim 1, further comprising:
accessing historical data stored on the endpoint device, wherein the historical data includes data associated with a newly added security feature executed by the security system, wherein the newly added security feature is added to the security system after the endpoint device has been added to the security system, and wherein the historical data comprises historical data not included in the historical data accessed during the initialization of the endpoint device on the secured network; and
instantiating a user behavior baseline for use by the newly added security feature using the accessed historical data.

3. The computer-implemented method of claim 1, wherein
the historical data accessed on the endpoint device during the initialization of the endpoint device on the secured network includes one or more of:
historical browser data;
historical file access data;
historical time-based data;
historical word processor data;
historical spreadsheet program data;
historical social media data;
historical email data; and
historical messaging data.

4. The computer-implemented method of claim 1, wherein
the instantiated user behavior baselines include one or more of:
a browser behavior baseline;
a file access behavior baseline;
a time-based behavior baseline;
a word processor behavior baseline;
a spreadsheet program behavior baseline;
a social media behavior baseline;
an email behavior baseline; and
a messaging behavior baseline.

5. The computer-implemented method of claim 1, further comprising:
instantiating a composite user behavior baseline using historical data from a plurality of historical data types, wherein the historical data types include a combination of at least two of:
historical browser data;
historical file access data;
historical time-based data;
historical word processor data;
historical spreadsheet program data;
historical social media data;
historical email data; and
historical messaging data.

6. The computer-implemented method of claim 1, further comprising:
communicating events occurring at the endpoint device to the security system;
comparing the communicated events to the user behavior baselines at the security system to determine whether the events correspond to anomalous user behavior; and
executing an automated operation if the events correspond to anomalous user behavior.

7. The computer-implemented method of claim 1, further comprising:
updating one or more user behavior baselines in response to events occurring at the endpoint device.

8. A system comprising:
one or more information handling systems, wherein the one or more information handling systems include:
a processor;
a data bus coupled to the processor; and
a non-transitory, computer-readable storage medium embodying computer program code, the non-transitory, computer-readable storage medium being coupled to the data bus;
wherein the computer program code included in one or more of the information handling systems is executable by the processor of the information handling system so that the information handling system, alone or in combination with other information handling systems, executes operations comprising:
accessing historical data stored on an endpoint device during an initialization of the endpoint device on a secured network;
instantiating user behavior baselines for the endpoint device using the accessed historical data; and
storing the instantiated user behavior baselines on a security system of the secured network for detecting instances of anomalous user behavior occurring at the endpoint device.

9. The system of claim 8, wherein the operations further comprise:
accessing historical data stored on the endpoint device, wherein the historical data includes data associated with a newly added security feature executed by the security system, wherein the newly added security feature is added to the security system after the endpoint device has been added to the security system, and wherein the historical data comprises historical data not included in the historical data accessed during the initialization of the endpoint device on the secured network; and
instantiating a user behavior baseline for use by the newly added security feature using the accessed historical data.

10. The system of claim 8, wherein
the historical data accessed on the endpoint device during the initialization of the endpoint device on the secured network includes one or more of:
historical browser data;
historical file access data;
historical time-based data;
historical word processor data;
historical spreadsheet program data;
historical social media data;
historical email data; and
historical messaging data.

11. The system of claim 8, wherein the instantiated user behavior baselines include one or more of:
a browser behavior baseline;
a file access behavior baseline;
a time-based behavior baseline;
a word processor behavior baseline;
a spreadsheet program behavior baseline;
a social media behavior baseline;
an email behavior baseline; and
a messaging behavior baseline.

12. The system of claim 8, wherein the operations further comprise:
instantiating a composite user behavior baseline using historical data from a plurality of historical data types, wherein the historical data types include a
combination of at least two of:
historical browser data;
historical file access data;
historical time-based data;
historical word processor data;
historical spreadsheet program data;
historical social media data;
historical email data; and
historical messaging data.

13. The system of claim 8, wherein the operations further comprise:
communicating events occurring at the endpoint device to the security system;
comparing the communicated events to the user behavior baselines at the security system to determine whether the events correspond to anomalous user behavior; and
executing an automated operation if the events correspond to anomalous user behavior.

14. The system of claim 8, wherein the operations further comprise:
updating one or more user behavior baselines in response to events occurring at the endpoint device.

15. A non-transitory, computer-readable storage medium embodying computer program code, the computer program code comprising computer-executable instructions configured for:
accessing historical data stored on an endpoint device during an initialization of the endpoint device on a secured network;
instantiating user behavior baselines for the endpoint device using the accessed historical data; and
storing the instantiated user behavior baselines on a security system of the secured network for detecting instances of anomalous user behavior occurring at the endpoint device.

16. The non-transitory, computer-readable storage medium of claim 15, wherein the instructions are further configured for:
accessing historical data stored on the endpoint device, wherein the historical data includes data associated with a newly added security feature executed by the security system, wherein the newly added security feature is added to the security system after the endpoint device has been added to the security system, and wherein the historical data comprises historical data not included in the historical data accessed during the initialization of the endpoint device on the secured network; and
instantiating a user behavior baseline for use by the newly added security feature using the accessed historical data.

17. The non-transitory, computer-readable storage medium of claim 15, wherein
the historical data accessed on the endpoint device during the initialization of the endpoint device on the secured network includes one or more of:
historical browser data;
historical file access data;
historical time-based data;
historical word processor data;
historical spreadsheet program data;
historical social media data;
historical email data; and
historical messaging data.

18. The non-transitory, computer-readable storage medium of claim 15, wherein
the instantiated user behavior baselines include one or more of:
a browser behavior baseline;
a file access behavior baseline;
a time-based behavior baseline;
a word processor behavior baseline;
a spreadsheet program behavior baseline;
a social media behavior baseline;
an email behavior baseline; and
a messaging behavior baseline.

19. The non-transitory, computer-readable storage medium of claim 15, wherein the instructions are further configured for:
instantiating a composite user behavior baseline using historical data from a plurality of historical data types, wherein the historical data types include a combination of at least two of:
historical browser data;
historical file access data;
historical time-based data;
historical word processor data;
historical spreadsheet program data;
historical social media data;
historical email data; and
historical messaging data.

20. The non-transitory, computer-readable storage medium of claim 15, wherein the instructions are further configured for:
communicating events occurring at the endpoint device to the security system;
comparing the communicated events to the user behavior baselines at the security system to determine whether the events correspond to anomalous user behavior; and
executing an automated operation if the events correspond to anomalous user behavior.
